(19) United States
(12) Patent Application Publication
(10) Pub. No.: US 2022/0015348 A1
(43) Pub. Date: Jan. 20, 2022

(54) INSECT TAPE TRAP

(71) Applicants: Nitto, Inc., Lakewood, NJ (US); Nitto Denko Corporation, Osaka (JP); The United States of America, as represented by the Secretary of Agriculture, Washington, DC (US)

(72) Inventors: Kujtim Bizati, Kingsport, TN (US); Yosuke Asamoto, Lakewood, NJ (US); Junwei J. Zhu, Lincoln, NE (US); Hironao Otake, Osaka (JP); LIU JEN-CHIEH, Lakewood, NJ (US)

(21) Appl. No.: 17/311,316

(22) PCT Filed: Oct. 26, 2019
(86) PCT No.: PCT/US19/58235

§ 371 Date: Jun. 4, 2021

Related U.S. Application Data
(60) Provisional application No. 62/750,883, filed on Oct. 26, 2018.

(51) Int. Cl. A01M 1/16; A01M 1/02

(52) U.S. Cl. CPC A01M 1/16; A01M 1/02

(57) ABSTRACT

An adhesive film for attracting and capturing flying insects and method of use are disclosed. The adhesive film includes an adhesive material, an olfactory attractant, a visual attractant and a tackifier. The method of use includes a barrier style trap or a log roll comprised of an adhesive film for attracting and capturing flying insects wound onto a central cylindrical core. The adhesive film may be unwound and attached to a second mounting apparatus. The log roll may be comprised of a continuous sheet of perforated adhesive film which comprises individual sheets wound, which may be removed from the log roll when the adhesiveness of the outer sheet is exhausted, exposing a fresh sheet.

### CROSS-REFERENCE TO RELATED APPLICATIONS

This application claims the benefit of U.S. Provisional Patent Application Ser. No. 62/750,883 filed Oct. 26, 2018, the content of which is incorporated herein by reference in its entirety.

### FIELD

This invention relates to the field of insect traps using olfactory attractants. In particular, this invention relates to adhesive compositions containing olfactory attractants and methods of using and preparing flying insect traps containing adhesive films comprising adhesive compositions containing olfactory and visual attractants.

### BACKGROUND

The present disclosure relates broadly to insect attracting and capturing traps, and specifically adhesives for attracting and capturing flying insects and more specifically flying insects of the genus Stomoxys. Stable flies (Stomoxys calcitrans), with their long excavating mouth parts, wound the skin and feed on the blood of livestock, resulting in reproductive failure, lower weight gain, and reduction in milk production causing economic losses. Stable flies are considered to be among the costliest arthropod pests to livestock, causing over $2.2 billion losses annually in the United States cattle industry.

Because stable flies migrate up to 5 miles to feed, it is very difficult to locate where they originate from. What is known, however, is that the flying behavior of the stable flies is very uniform, flying close to the ground (below 1 meter). After biting the livestock, the stable flies immediately head back to their various resting areas on shaded vertical surfaces to digest the blood of the livestock over the next 24 hours. It is also known that stable flies like to take breaks while flying to those resting areas. Around livestock pastures and pens, stable flies like to rest on the shady side of fence posts and watering troughs, lying in wait for the livestock to come near to feed on their blood again.

Control of stable fly populations in confined livestock pastures and pens has focused primarily on sanitation and the use of insecticides with mixed results. The use of sanitation procedures is costly, and insecticides provide minimal control of fly populations that visit their hosts for only short periods of time each day. Furthermore, there are reports suggesting that stable flies build up resistance to insecticides, primarily with organochlorine and organophosphate insecticides. Recently, one researcher has identified several populations of stable flies in Florida that were resistant to permethrin, the most commonly used insecticide for stable fly management.

One effective method for control of biting flies include ear tags which contain pesticides. The ear tags work by spreading pesticides around the head and upper body parts, preventing horn flies from attacking the face and portions of the upper back regions of the livestock. Ear tags work well for control of flies around the head region, but have little to no effect on stable flies, which usually attack at the legs and underbellies of the livestock, because the pesticide cannot reach these regions. Another method employed to control the stable fly around the legs and bellies of the livestock utilized a tape containing fly repellent applied to the livestock legs. The leg tape proved to have a short repellent life and the tape peeled off easily, rendering the leg tape ineffective. Another disadvantage was the tape had to be applied to all of the livestock within the pasture or pen, consuming a great deal of time and resources. Other reported methods include the use of asinine cylinder sticky trap and panel traps with lure containing attractant, Tangtrakulwanich, K. et. al., Behavioral Responses of Stable Flies to Cattle Manure Slurry Associated Odorants, Medial and Veterinary Entomology, vol. 15, (2015), pp. 82-87; Zhu, J, et. al., Visual and Olfactory Enhancement of Stable Fly Trapping, Pest Management Science, vol. 72, no. 9, (2015), pp. 1765-1771. The disadvantages with these style traps are that the alsynite is becoming increasingly difficult to obtain and is cost prohibitive in a feed lot or pasture environment, while the panel traps with attractant lures have a short attracting life and require frequent lure changes leading to prohibitive economic and resource depletion in livestock operations.

Novel techniques for managing biting flies are needed. Methods of the present disclosure take advantage of the stable fly's host animal search behavior, by combining visual and olfactory attractants in an adhesive film, to create large barrier style traps placed at ground level and extending vertically, up to a height that is substantially the same as the height of adult livestock (about 1-2 m), within the flight path of the stable flies. Another method of the present disclosure takes advantage of the stable fly's habit of resting on vertical shady surfaces, wherein traps that comprise log rolls of perforated adhesive sheets for attracting and capturing flying insects are placed around and among the pastures or pens, creating an adhesive vertical surface such that when the flies land to rest and lie in wait for the livestock, they become trapped and die. One advantage of the log roll barrier traps is they provide a substantial coverage area on very large fields. Another advantage of the present disclosure, over existing methods, is the attractive properties do not allow the stable flies to develop immunity toward the trap, since attractants rather than repellents are utilized. It is believed that the present disclosure will enable cost-effective methods of controlling the stable fly populations in a livestock pasture or pen setting or breeding sites. In addition, these methods can also be applied to reduce stable fly attacks on other animals such as horses and companion animals (pets), as well as to humans because when no livestock animals are available, stable flies tend to attack people, especially at the beach and other recreational areas.

### SUMMARY

This disclosure relates to insect traps and more particularly flying insect traps. Also described herein are flying insect traps utilizing an adhesive film for attracting and capturing flying insects, wherein the adhesive for attracting and capturing flying insects can comprise one or more visual attractants, one or more olfactory attractants, or combinations thereof. Also described herein are methods for using said adhesives for attracting and capturing flying insects.

In some embodiments, the adhesive can be comprised of an adhesive material and at least one additive. In some embodiments, the adhesive material can comprise a pressure sensitive adhesive. In some embodiments, the adhesive material may be comprised of a thermoplastic adhesive material. In some embodiments, the at least one additive can comprise at least one olfactory attractant. In some embodiments, the at least one additive can comprise a tackifier.

Some embodiments describe the adhesive material, wherein the adhesive material may be comprised of an acrylic polymer, a polyisobutylene, a polybutene, a synthetic rubber, or combinations thereof. In some embodiments, the adhesive material can be comprised of an acrylic polymer. In some embodiments, the acrylic polymer can comprise 2-methylhexyl acrylate, n-butyl acrylate, and acrylic acid.

In some embodiments, the at least one olfactory attractant may be comprised of the tackifier, a volatile organic small molecule, or combinations thereof. In some embodiments, the at least one olfactory attractant may be comprised of a volatile small molecule. In some embodiments, the volatile organic small molecule can be miscible in the adhesive material. In some embodiments, the volatile organic small molecule can be described as a phenol, m-cresol, p-cresol, 1-octen-3-ol, 1hexanol, or combinations thereof. In some embodiments, the volatile organic small molecule may be m-cresol. In other embodiments, the at least one olfactory attractant may be comprised of the tackifier. In still other embodiments, the at least one olfactory attractant can be comprised of a combination of a tackifier and at least one volatile small molecule.

In some embodiments, the tackifier can be comprised of rosin ester, a xylene resin, a terpene resin, an aliphatic/aromatic hydrocarbon rosin ester or combinations thereof. In another embodiment, the tackifier can comprise a hydrogenated rosin ester. In some embodiments, the amount of tackifier can be about 60 to about 200 wt % of the total weight of the adhesive material.

In still another embodiment, the flying insect can comprise a flying insect of the genus Stomoxys. In still another embodiment, the flying insect can further be a stable fly (Stomoxys calcitrans).

Some embodiments can describe an adhesive for attracting and capturing flying insects as an adhesive film. In some embodiments, the adhesive film can be comprised of at least an adhesive layer and a backing layer. In some embodiments, the adhesive layer can be about 25 μm to about 100 μm thick. In some embodiments, the backing layer can be comprised of a polyethylene terephthalate material. In some embodiments, the backing layer can further comprise a visual attractant. In some embodiments, the backing layer may be white. In some embodiments, the adhesive film can be described as further comprising a release liner or release coating.

Other embodiments describe an adhesive film as comprising a log roll. In some embodiments, the adhesive film can comprise a log roll. The log roll is comprised of the adhesive film wound around a cylindrical core. In some embodiments, the adhesive layer is lateral to and in physical contact with the cylindrical core and the backing layer of the adhesive film is medial to the cylindrical core. In some embodiments, the log roll can comprise an insect barrier trap, with a bottom edge and a top edge. The bottom edge is located as close to the ground as possible and the top edge of the barrier trap extends vertically to a height in the range of about 12 cm to about 1 m.

Some embodiments describe a method for using a barrier trap, the method comprising a log roll of adhesive film for attracting and capturing flying insects around a livestock pasture or pen comprising the steps of: a) locating a livestock pasture or pen in need of flying insect control; b) erecting a plurality of mounting devices for the mounting of log rolls around at least a portion of the outer perimeter of the livestock pasture or pen such that the pasture or pen is flanked by the mounting device, the mounting devices comprising a first mount and a second mount spaced up to 3 meter distance from each other and running parallel to the perimeter of the livestock pasture or pen; c) mounting a log roll of adhesive film for attracting and capturing flying insects on the first mount; and d) unwinding the roll of adhesive film for attracting and capturing flying insects and fixably attaching the film to the second mount, creating a barrier trap. In some embodiments, the log roll of adhesive film for attracting and capturing flying insects can be mounted such that when the barrier is created the bottom edge of the barrier is located as close to or at ground level and extending upward, so that the barrier is substantially within the flight path of the flies. In other embodiments of the method, the adhesive film for attracting and capturing flying insects can be wound onto the second mount at such a time as when the exposed portion of film's adhesiveness is exhausted and a fresh area of film for attracting and capturing flying insects is needed.

In still another embodiment, the log roll of adhesive film is wound around a cylindrical core, the backing layer is medial/proximal and in physical contact with the tubular core and adhesive layer is lateral/distal to the tubular core, wherein the perforations create individual sheets which can be separated from the log roll when a sufficient amount of force is applied. In some embodiments, the log roll of perforated adhesive film can further comprise a release liner, wherein the release liner can be disposed on and in physical communication with the adhesive layer.

Another embodiment describes a method for using a log roll of perforated adhesive film for attracting and capturing flying insects comprising the steps of: a) identifying a livestock pasture or pen in need of flying insect control; b) erecting a plurality of log rolls of perforated adhesive film for attracting and capturing flying insects near or around a livestock pasture or pen; c) exposing the adhesive film to the environment; d) removing the outer sheet of the adhesive film when the adhesiveness of the outer layer is exhausted, revealing a fresh layer of adhesive film; e) Repeating steps a, b, c, and d as needed and then replacing the log roll when all sheets have been depleted; and f) repeating the steps, a, b, c, d, and e as needed.

Any combination of the groups described above for various variables is contemplated herein. It is understood that combinations of various groups of organic polymers, olfactory attractants, and additives can be selected by one of ordinary skill in the art to provide an organic polymer that can be miscible with the olfactory attractant and that can be synthesized by techniques known in the art, as well as those set forth herein.

### BRIEF DESCRIPTION OF THE DRAWINGS

FIG. 1 Depicts an embodiment of the adhesive material.

FIG. 2A Depicts an embodiment of the adhesive film for attracting and capturing flying insects.

FIG. 2B Depicts an embodiment of the adhesive film for attracting and capturing flying insects

FIG. 2C Depicts an embodiment of the adhesive film for attracting and capturing flying insects.

FIG. 2D Depicts an embodiment of the adhesive film for attracting and capturing flying insects.

FIG. 3 An illustration of one embodiment of a log roll of adhesive film for attracting and capturing flying insects with mounting device.

FIG. 4 An illustration of a preferred embodiment of a log roll of adhesive film for attracting and capturing flying insects with mounting device.

FIG. 5 A depiction of a preferred method of using the insect attracting and capturing film log rolls.

FIG. 6 An illustration of one of the embodiments of a log roll of adhesive film for attracting and capturing flying insects with mounting device.

FIG. 7 A depiction of a method of using a log roll of perforated sheets of adhesive film for attracting and capturing flying insects.

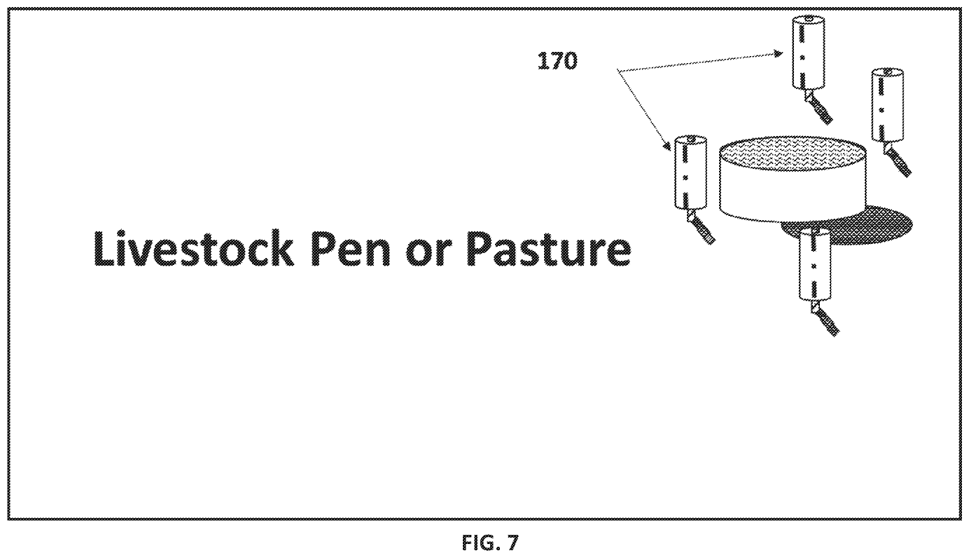

FIG. 8 A bar graph representing the levels of the m-cresol in a fresh piece of adhesive for an experiment described herein.

FIG. 9 A graph of the m-cresol levels in a piece of adhesive for an experiment described herein.

FIG. 10 A picture of a laboratory experiment showing a screen cage where two strips of adhesive film, one infused with an attractant (SA-1, SA-2, SA-3, or SA-4) and one without an attractant (control), was affixed onto a wall of the cage and thirty stable flies were released into the cage to test which strip attracted more flies.

FIG. 11A A graph of the number of stable flies caught on a strip comprised of a disclosed embodiment compared to a control.

FIG. 11B A graph of the number of stable flies caught on a strip comprised of a disclosed embodiment compared to a control.

FIG. 11C A graph of the number of stable flies caught on a strip comprised of a disclosed embodiment compared to a control.

FIG. 11D A graph of the number of stable flies caught on a strip comprised of a disclosed embodiment compared to a control.

FIG. 12A A depiction of a field experiment utilizing cattle mimicking devices (panel traps) surrounded by mounting devices of adhesive film, compared to devices that were not surrounded.

FIG. 12B A graph of the mean number of stable flies caught per panel trap that is surrounded by mounting devices of the adhesive film compared to panels that were not surrounded.

FIG. 13 A graphical illustration comparing the total number of flies captured in a field per trap with and without an olfactory attractant added to the adhesive material.

FIG. 14 A graphical illustration comparing the total number of flies captured in a field per trap with and without an olfactory attractant, and with different visual attractants.

### DETAILED DESCRIPTION

Flies and more specifically stable flies (Stomoxys calcitrans) are blood feeding flies that cause extensive economic impact in the livestock industry. The fly's behavior leads to reduced weight gain and lower milk production in cattle. Current fly control primarily focuses on sanitation and the use of insecticides. The problem is that sanitation procedures are costly and insecticides provide marginal control at best, and there is evidence that flies are developing resistance to the current insecticides. The present disclosure relates to an adhesive material for attracting and capturing insects. The adhesive material includes adhesive materials that are relatively soft, such that, at ambient temperatures the adhesive material will retain its tackiness, but relatively firm enough so that the adhesive material will retain its structure. The adhesive material may also comprise olfactory attractant, which can be miscible within the adhesive material. The adhesive material may be incorporated into a film comprising a backing layer. The film can be used for the capture of insects. The backing layer of the film may comprise a visual attractant. The visual attractant may have an Ultra Violet (UV) reflectance wavelength between about 300 nm to about 440 nm. The adhesive may further comprise a tackifier.

As used herein the term “attractant” refers to any composition, chemical, or visual stimuli that draws an insect toward a particular location. Attractants include thermostimuli, mechanostimuli (e.g., sound waves or pressure waves), electromagnetic stimuli (including visual stimuli such as patterns, objects, color, or light), and chemical stimuli (including odors or vapors). A chemical attractant can be a compound or a composition, including more than one compound, which either directly or indirectly elicits a positive directional response from an insect, drawing the insect to a location at or near the source of the stimuli.

As used herein the term “volatile” refers to compounds and/or compositions that can be readily vaporized at ambient temperatures. As used herein the term “log roll” refers to the roll created when a long section of insect attracting and capturing film is wound onto a center tubular core.

As used herein the term “medial” or “proximal” refers to the surface or side that is closest to the cylindrical core of the log roll. Thus, if a surface is recited herein as medial on a log roll, said surface is facing the center tubular core of the roll.

As used herein the term “lateral” or “distal” refers to the surface or side that is farthest away from the cylindrical core of the log roll. Thus, if a surface is recited herein as lateral on a log roll, said surface is facing away from the tubular core of the roll.

As used herein the term “organic volatile small molecule” refers to an organic molecule with a molecular weight of less than about 900 Daltons that vaporizes at temperature range of between about 10° C. to about 55° C.

For purposes of promoting an understanding of the present disclosure, reference will now be made to the following embodiments and specific language will be used to describe the same. It will nevertheless be understood that no limitation of the scope of the disclosure is thereby intended, such alterations and further modifications in the described subject matter, and such further applications of the disclosed principles as described herein being contemplated as would normally occur to one skilled in the art to which the disclosure relates.

The current disclosure relates to insect traps and methods for use. More specifically, the current disclosure relates to insect attracting and capturing film utilizing olfactory attractants, visual attractants and/or combinations thereof. The film may be comprised of an adhesive layer to and a backing layer.

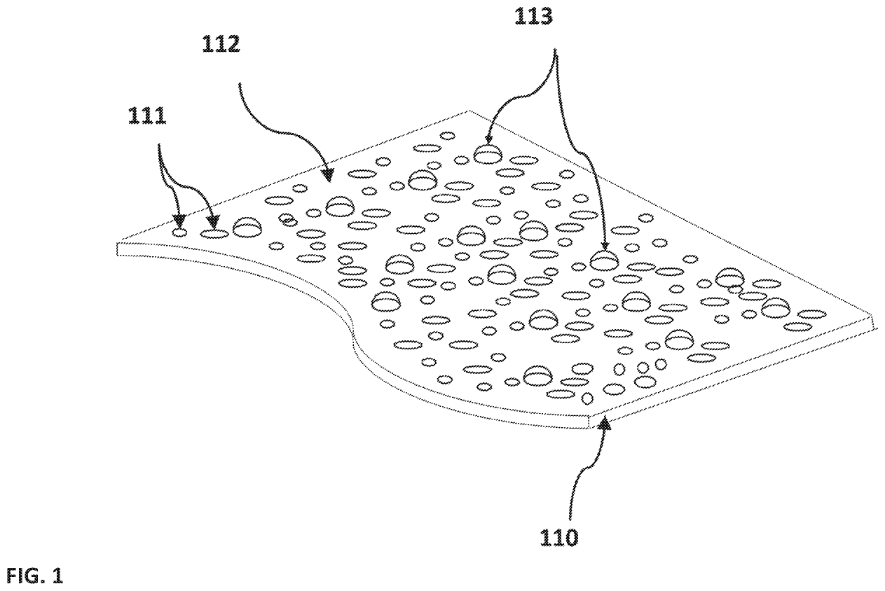

FIG. 1. represents an illustrated rendering of the adhesive layer; it should be noted that the illustration is depicted only to illustrate the adhesive and does not limit the adhesive material in any way. The illustration depicts an olfactory attractant 111, and a tackifier 113, as separate domains within the adhesive, for illustrative purpose only, as the olfactory attractant and the tackifier are miscible within the adhesive. In some embodiments the adhesive layer 110, for attracting and capturing flying insects is described. The adhesive layer can comprise an adhesive material, 112, the adhesive material being sufficiently tacky to act as a physical restraint to flying insects that come in contact with adhesive. In some embodiments, the adhesive material may comprise at least one olfactory attractant.

### Adhesive

The adhesive layer comprises an adhesive material and additives. The adhesive material can comprise any adhesive with sufficient tackiness for capturing and retaining insects upon contact. The adhesive material may be selected for its ability to maintain structure and tackiness at ambient temperature. The adhesive material is not-limiting and one skilled in the art would be able to identify which adhesive materials to use. In some embodiments, the adhesive material may be comprised of a thermoplastic adhesive material. In some embodiments, the adhesive material may be any color or shade of transparent, translucent, or opaque. In other embodiments, the adhesive material may be white. In still other embodiments, the adhesive material may be pink. In some embodiments, the adhesive material can comprise an organic polymer. In some embodiments, the organic polymer may be comprised of acrylic polymers, polyisobutylene, polybutene, synthetic rubber, and/or combinations thereof.

In some embodiments, the organic polymer can comprise an acrylic polymer. In some embodiments, the acrylic polymer can be comprised of acrylate monomers. The acrylate monomer may be chosen from among 2-methylhexyl acrylate, 2-ethylhexyl acrylate, iso-butyl acrylate, n-butyl acrylate, methoxy polyethylene glycol acrylate, acrylic acid, and/or combinations or mixtures thereof. Some other non-limiting examples of acrylate monomers include 4-acetoxyphenethyl acrylate, benzyl 2-propyl acrylate, butyl acrylate, tert-butyl acrylate, 2-carboxyethyl acrylate, 2-chloroethyl acrylate, 2-(dimethylamino)ethyl acrylate, ethylacrylate, ethyl 2-(bromomethyl)acrylate, ethylene glycol dicyclopentenyl ether acrylate, ethylene glycol methyl ether acrylate, ethyl 2-ethyl acrylate, hexyl acrylate, iso-decyl acrylate, laurel acrylate, iso-octyl acrylate, methyl acrylate, poly(ethylene glycol)methyl ether acrylate, tetrahydrofufuryl acrylate, and 3,5,5-trimethylhexyl acrylate to name a few. In some embodiments, the acrylic polymer can be comprised of 2-ethyhexyl acrylate, iso-butyl acrylate, methoxy polyethylene glycol acrylate, and acrylic acid. The acrylic polymer can be comprised of about 53% to about 73% 2-ethylhexyl acrylate, about 23% to about 43% iso-butyl acrylate, about 0.5% to about 1.5% methoxy polyethylene glycol acrylate, and about 0.5% to about 4% acrylic acid. In another embodiment, the acrylic polymer can be comprised of 2-methylhexyl acrylate, n-butyl acrylate, and acrylic acid. The acrylic polymer can be comprised of about 60% to about 80% 2-metylhexyl acrylate, about 18.5% to about 38.5% n-butyl acrylate and about 0.5% to about 1.5% acrylic acid.

In some embodiments, the adhesive material can comprise a synthetic rubber polymer, such as those comprised of polystyrene polymers. Polystyrene polymers can be comprised of styrene block copolymer such as diene block copolymer of styrene/isoprene/butadiene/styrene (SIBS) rubbers or styrene/isoprene (SI) rubbers. Other specific examples of rubber-based polymers include but are not limited to block copolymers of styrene and a conjugated diene such as styrene-butadiene (SB) rubbers, styrene/butadiene/styrene (SBS) rubbers, styrene/ethylene/propylene (SEP) rubbers, and styrene/ethylene/propylene/styrene (SEPS) rubbers.

The adhesive material forms a component of the adhesive layer. The adhesive layer is preferably about 5μm to about 260 μm thick. In some embodiments, the adhesive layer is more preferably about 20 μm to about 200 μm thick. In some embodiments the adhesive layer is still more preferably about 25 μm to about 100 μm thick. In some embodiments, the adhesive layer can be about 25 to about 30 μm, about 30 to about 35 μm, about 35 to about 40 μm, about 40 to about 45 μm, about 45 to about 50 μm, about 50 to about 55 μm, about 55 to about 60 μm, about 60 to about 65 μm, about 65 to about 70 μm, about 70 to about 75 μm, about 75 to about 80 μm, about 80 to about 85 μm, about 85 to about 90 μm, about 90 to about 95 μm, about 95 to about 100 μm, about 100 to about 105 about 105 to about 110 about 110 to about 115 about 115 to about 120 about 120 to about 125 about 125 to about 130 about 130 to about 135 about 135 to about 140 about 140 to about 145 about 145 to about 150 about 20 μm, about 25 μm, about 30 μm, about 40 μm, about 45 μm, about 50 μm, about 60 um, about 65 μm, about 75 μm, about 100 μm, about 125 about 150 or any thickness bound by these ranges.

### Olfactory Attractant

The adhesive material can be comprised of one or more olfactory attractants, which may come in a variety of forms. For example, the olfactory attractant may be comprised of odorants, pheromones, chemicals, and/or anything else that an insect would be drawn to. In the present disclosure, the adhesive layer includes at least one olfactory attractant. The at least one olfactory attractant can be miscible within the adhesive material. The at least one olfactory attractant can be useful in attracting a variety of insects including house flies (Musca domestica), stable flies (Stomoxys calcitrans), face flies (Musca autumnalis), and a variety of flying insects that can be found in and around livestock facilities. In some embodiments, the olfactory attractant can be comprised of a tackifier, a volatile organic small molecule, and/or combinations thereof. An olfactory attractant can be any olfactory stimulant as long as the olfactory attractant attracts flying insects. In some embodiments, the flying insect can be flies of the genus Stomoxys. In some embodiments, the flying insects can be stable flies (Stomoxys calcitrans).

In some embodiments, the at least one olfactory attractant can comprise a volatile organic small molecule. In some embodiments, the volatile organic small molecule can be miscible within the adhesive material. In some embodiments, the volatile organic small molecule can comprise a phenol, m-cresol, p-cresol, 1-octen-3-ol, 1-hexanol, and/or combinations thereof. In some embodiments, the volatile organic small molecule can comprise m-cresol.

The volatile organic small molecule can be infused/mixed within the adhesive material 112. One skilled in the art can determine the amount of volatile organic small molecule to be infused/mixed within the adhesive material. For example, the amount of volatile organic small molecule infused/mixed into the adhesive material can generally be about 0.1 wt % to about 100 wt % of the total weight of the adhesive material and preferably about 1 wt % to about 50 wt % and more preferably about 5 wt % to about 30 wt % of the total weight of the adhesive material. In some embodiments the volatile organic small molecule can be about 0.1 wt % to about 5 wt %, about 5 wt % to about 10 wt %, about 10 wt % to about 15 wt %, about 15 wt % to about 20 wt %, about 20 wt % to about 25 wt %, about 25 wt % to about 30 wt %, about 30 wt % to about 35 wt %, about 35 wt % to about 40 wt %, about 40 wt % to about 45 wt %, about 45 wt % to about 50 wt %, about 50 wt % to about 55 wt %, about 55 wt % to about 60 wt %, about 60 wt % to about 65 wt %, about 65 wt % to about 70 wt %, about 70 wt % to about 75 wt %, about 75 wt % to about 80 wt %, about 80 wt % to about 85 wt %, about 85 wt % to about 90 wt %, about 90 wt % to about 95 wt %, about 95 wt % to about 100 wt %, about 7 wt %, about 8 wt %, about 9 wt %, about 10 wt %, about 11 wt %, about 12 wt %, about 13 wt %, about 14 wt %, or about 15 wt %, or any amount bound by the listed ranges.

In some embodiments, the at least one olfactory attractant can be comprised of the tackifier, 113.

### Tackifier

In some embodiments, the adhesive material can comprise a tackifier. The tackifier is not particularly limited. In some embodiments, the tackifier can comprise rosin derivative resins, xylene resins, terpene resins, and/or aliphatic/aromatic hydrocarbon resins. Some non-limited examples of rosin derivatives include unmodified rosins such as gum rosin, wood rosin, tall-oil resin, etc.; modified rosins (hydrogenated rosins, disproportionate rosins, polymerized rosins, other chemically-modified rosins, etc., and the same applies hereinafter) obtained from these unmodified rosins via modifications such as hydrogenation, disproportionation polymerization, etc.; various other rosin derivatives; and the like. Examples of the rosin derivatives include rosin esters, hydrogenated rosin esters, and unmodified rosins esterified with alcohol. Non-limited examples of terpene resin include α-pinene polymer β-pinene polymer, dipentene polymer, aromatic modified terpene resins, hydrogenated terpene resins, and terpene-phenol resins. Non-limited examples of xylene resins include phenol-formaldehyde resins and alkylphenol-formaldehyde resins. Non-limited examples of aliphatic/aromatic hydrocarbon resins include aliphatic petroleum resins, aromatic petroleum resins, and alicyclic petroleum resins. In some embodiments, the tackifier can comprise a rosin ester. In other embodiments, the tackifier can comprise a hydrogenated rosin ester.

In some embodiments, the olfactory attractant can be comprised of the tackifier.

The amount of tackifier contained in the adhesive material may be dependent on the thickness of the adhesive layer. In some embodiments, the adhesive material may be a component of adhesive layer of a film with an adhesive layer and a backing layer. In some embodiments where the film is wound around a core, if the amount of tackifier is too high (e.g., above about 150 wt %), then the thickness of the adhesive layer may have to be below about 50 μm, in order for the adhesive layer to release well from the backing layer. In some non-limited examples, the adhesive material forms a film, in this example the thickness of the adhesive layer in the film would determine the amount of the tackifier. The amount of tackifier can be determined by one skilled in the art. For example, the amount of tackifier can be about 1 wt % to about 500 wt % of the total weight of the adhesive material, and more preferably about 50 wt % to about 200 wt %, and still more preferably 80 wt % to about 150 wt %. In some embodiments, the amount of tackifier can be about 1 wt % to about 25 wt %, about 25 wt % to about 50 wt %, about 50 wt % to about 100 wt %, about 100 wt % to about 125 wt %, about 125 wt % to about 150 wt %, about 150 wt % to about 200 wt %, about 200 wt % to about 225 wt %, about 225 wt % to about 250 wt %, about 250 wt % to about 300 wt %, about 300 wt % to about 350 wt %, about 350 wt % to about 400 wt %, about 400 wt % to about 450 wt %, about 450 wt % to about 500 wt %, about 80 wt % to about 85 wt %, about 85 wt % to about 90 wt %, about 90 wt % to about 95 wt %, about 95 wt % to about 100 wt %, about 100 wt % to about 105 wt %, about 105 wt % to about 110 wt %, about 110 wt % to about 115 wt %, about 115 wt % to about 120 wt %, about 120 wt % to about 125 wt %, about 125 wt % to about 130 wt %, about 130 wt % to about 135 wt %, about 135 wt % to about 140 wt %, about 140 wt % to about 145 wt %, about 145 wt % to about 150 wt %, about 60 wt %, about 120 wt %, about 200 wt %, or any amount bound by the ranges cited herein.

### Cross-Linker

In some embodiments, the adhesive material can further comprise a cross-linker. Examples of cross-linkers include isocyanate cross-linkers, epoxy cross-linkers, melamine cross-linkers, and peroxide cross-linkers, as well as urea cross-linkers, metal alkoxide cross-linkers, metal chelate cross-linkers, metal salt cross-linkers, carbodiimide cross-linkers, oxazoline cross-linkers, aziridine cross-linkers, and amine cross-linkers, of which, isocyanante cross-linkers, and epoxy cross-linkers are preferred. Examples of isocyanate cross-linkers include lower aliphatic polyisocyanates, alicyclic polyisocyanates, and aromatic polyisocyanates. Examples of epoxy cross-linkers include N,N,N′,N′-tertraglycidyl-m-xylenediamine, diglycidylaniline, 1,3-bis(n,N-glycidylaminomethyl)cyclohexane, 1,6-hexanediol diglycidyl ether, neopentyl glycol diglycidyl ether, ethylene glycol diglycidyl ether, proplylene glycol diglycidyl ether, polyethylene glycol diglycidyl ether, sorbitol polyglycidyl ether, glycerol polyglycidyl ether, pentaerythritol polygylcidyl ether, polyglycerol polyglytcidyl ether, diglycidyl ester of o-phthalic acid, triglycidyl-tris(2-hy-droxyethyl) isocyanurate, resorcinol diglycidtyl ether, bisphenol-S-diglycidyl ether, and epoxy resins having two or more epoxy groups per molecule. In some embodiments, the cross-linker can be comprised of a metal chelate, an isocyanate, and/or an epoxy cross-linker.

In some embodiments, the adhesive material can further comprise a solvent. The choice of solvent used is not particularly limited and one skilled in the art could determine which solvent to use from those known in the art for the particular adhesive material used. In some embodiments, the solvent may comprise ethyl acetate, methyl ethyl ketone, toluene, and/or combinations thereof. In one particular embodiment, the solvent can comprise ethyl acetate. In some embodiments, the amount of ethyl acetate can be from about 0 to about 100 wt % of the total weight of the adhesive material. Preferably in some embodiments, ethyl acetate can comprise about 10 wt % to about 70 wt % of the total weight of the adhesive material. And more preferably in some embodiments, ethyl acetate can comprise about 25 wt % to about 60 wt % of the total weight of the adhesive material.

### Adhesive Film

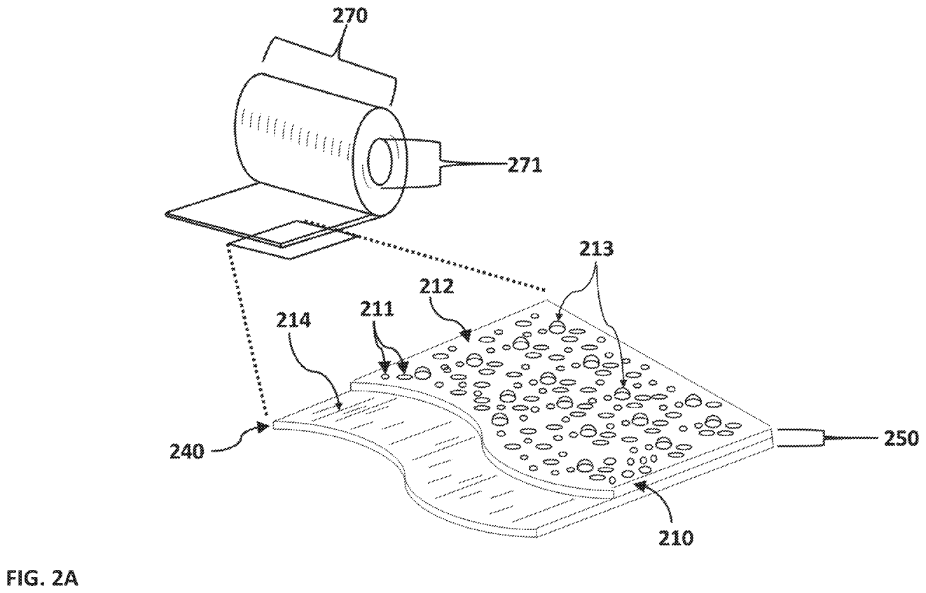

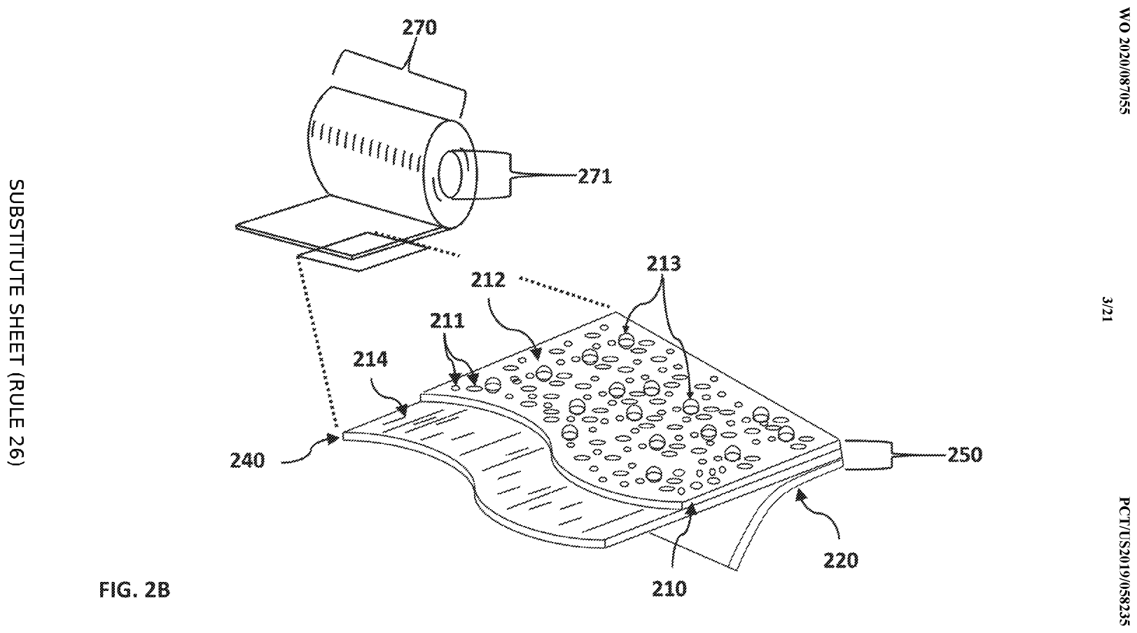

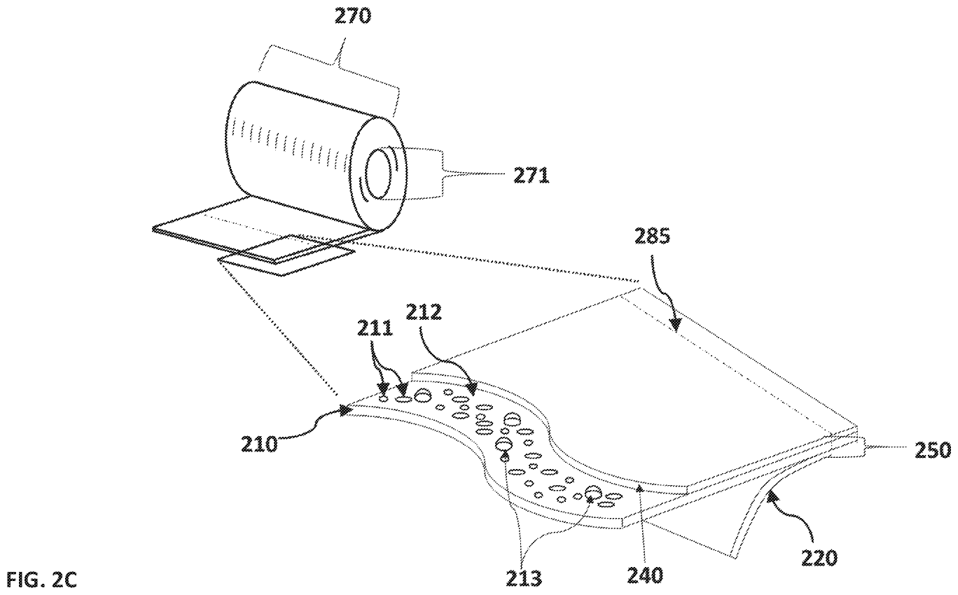

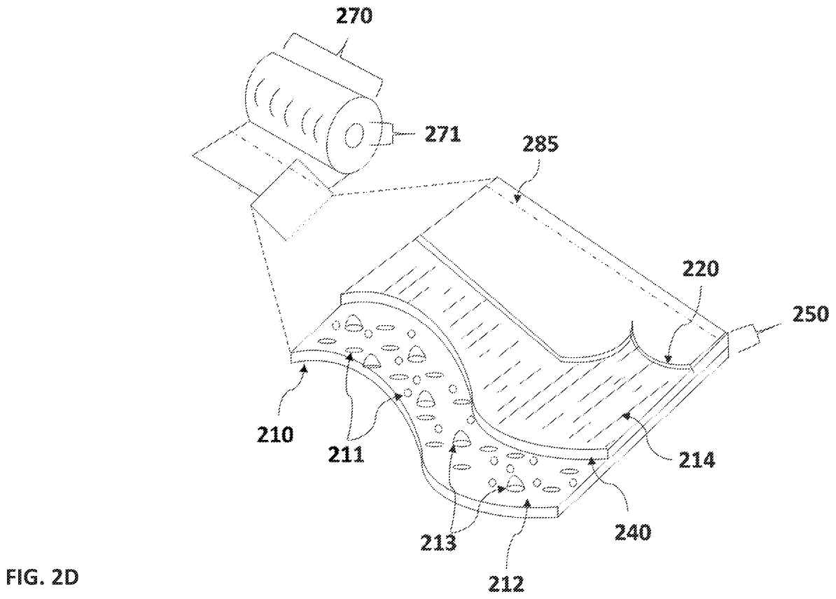

In some embodiments, the aforedescribed adhesive material can comprise an insect attracting and capturing film (“film”), wherein the film can comprise an adhesive layer and a backing layer. Referring now to FIGS. 2A, 2B, 2C, and 2D, some embodiments describe the film as comprising a backing layer 240, wherein the backing layer comprises a first side and a second side, and the second side is in planar opposition from the first side. In some embodiments, film can comprise an adhesive layer 210, wherein the adhesive layer can be comprised of a first side and a second side, and the second side is in planar opposition from the first side. In some embodiments, the first side of the adhesive layer can be disposed and in physical communication with the first side of the backing layer. In some embodiments, the second side or the exposed side of the adhesive layer can be exposed, as shown in FIG. 2A. In some embodiments, a release liner 220 can be disposed on the second or exposed side of the adhesive layer as shown in FIG. 2C. In some embodiments, the release liner can be disposed on the second or exposed side of the backing layer 240, as shown in FIGS. 2B and 2D. In some embodiments, the release liner may be disposed on the outer most sheet of adhesive film as a protectant from such things as dirt and oils which may become adhered to the surface during shipping and handling of the log roll. In embodiments where the release liner only covers the outermost sheet, the liner is removed when the log roll is erected in a location for use as a fly attracting and capturing device. Some embodiments describe an adhesive film, wherein the adhesive layer can be about 25 μm to about 100 μm thick. In some embodiments, the adhesive material 212, can be one as described herein above. In some embodiments, the adhesive material can comprise at least one olfactory attractant 211. In some embodiments, the at least one olfactory attractant can be comprised of at least one tackifier 213, a volatile organic small molecule, and/or combinations thereof. In some embodiments, the volatile organic small molecule can be miscible within the adhesive material. It is believed that if the adhesive layer is too thin, for example, such as, under about 25 μm, the olfactory attractant will evaporate quickly, rendering the attractant ineffective.

In some embodiments, the adhesive film can comprise a double-sided film. The double-sided film comprises a backing layer intermediate of two adhesive layers. In some embodiments, the double-sided adhesive film can further comprise at least one release liner, said release liner disposed on an exposed surface of an adhesive layer. In some embodiments, the double-sided adhesive film can be comprised of two release liners, wherein the two release liners are disposed on the exposed surfaces of the two adhesive layers.

### Backing Layer

In some embodiments, the film can comprise a backing layer. In some embodiments, the backing layer can be comprised of a first side and a second side in planar opposition of each other. In some embodiments, the first side of the backing layer can have the adhesive layer disposed thereon. In some embodiments, the second side of the backing layer can comprise a releasable surface comprising a silicon material. In some embodiments, the second side of the backing layer can have a release liner 220, as shown in FIGS. 2B and 2D, disposed thereon. The backing layer is not particularly limited and one skilled in the art could select a backing layer from those known in the art for the purpose of structural support. In some embodiments, the backing layer can be comprised of non-woven material, woven material or a woven substrate. Examples of woven substrates include but are not limited to silica (glass) aramid, carbon fiber, metal oxide, minerals, ceramic, or other synthetic man-made fibers. Some non-limited examples of non-woven materials include cellulose, rayon, cloth polyamide fluoride (PVDF), polyethylene (PE), polyethylene terephthalate (PET), polyether ketone (PEEK), and/or mixtures thereof. In some embodiments, the backing layer can be comprised of polyethylene terephthalate.

A backing layer can further comprise a releasing treatment such as a silicone treatment, a long chain alkyl treatment or a fluorine treatment on one side of the backing layer to improve the peeling/releasing properties from the adhesive layer. Further ultraviolet ray anti-transmission treatment(s) or the like may also be carried out as needed to protect the adhesive layer from reacting with the environmental ultraviolet rays.

In the present disclosure the adhesive film for attracting and capturing flying insects 250, includes a visual and at least one olfactory attractant. The backing layer may comprise the visual attracting component 214. In some embodiments, the backing layer can comprise a visual attractant. It is known that visual stimulus in flying insects and more particularly flies play an important role in their behavior. Because over half of the head of a fly is comprised of two large eyes, which convert the light photons to electrical signals which are relayed to the fly's brain, flies rely on reflected sunlight to detect objects in their environments while flying. It is believed that different light reflectance elicits changes in fly behavior such as attraction or repulsion. It is further believed that the spectral reflectance characteristics of white and light pink spectra in the wavelength range of about 330 nm to about 400 nm elicits a strong response/attraction within stable flies. In some embodiments the, backing layer can be white in color. In other embodiments, the backing layer can be pink in color. In some embodiments, the visual attractant can comprise a pattern. In some embodiments, the visual attractant's pattern can be comprised of alternating vertical or horizontal black and white stripes imprinted on the backing layer. In some embodiments, the backing layer can be blue, black, red, green, yellow, or a combination thereof. In still other embodiments, the backing layer can be a combination of white and pink color blended together or in coordination of white and pink patterns imprinted on the backing layer.

In some embodiments, the backing layer can be about 10 μm to about 250 μm thick. In a preferred embodiment, the backing layer can be about 20 μm to about 200 μm thick. In a more preferred embodiment, the backing layer can be about 25 μm to about 100 μm thick. In some embodiments, the backing layer can have a thickness of about 20 to about 25 μm, about 25 to about 30 μm, about 30 to about 35 μm, about 35 to about 40 μm, about 40 to about 45 μm, about 45 to about 50 μm, about 50 to about 55 μm, about 55 to about 60 μm, about 60 to about 65 μm, about 65 to about 70 μm, about 70 to about 75 pm, about 75 to about 80 μm, about 80 to about 85 μm, about 85 to about 90 μm, about 90 to about 95 μm, about 95 to about 100 μm, about 25 μm, about 30 μm, about 40 μm, about 50 μm, about 60 μm, about 70 μm, about 80 μm, about 90 μm, about 100 μm, or any thickness bound by these ranges.

### Release Liner

In some embodiments, the adhesive film can further comprise a release liner 220, as shown in FIGS. 2B and 2C. In some embodiments, the release liner can be disposed on the side of the backing layer that is in opposition with the adhesive layer. In some embodiments, the release liner can be disposed on the adhesive layer of the outer most adhesive layer film of a perforated adhesive film log roll, wherein the release liner protects the adhesive layer from dirt and debris until such a time as the adhesive layer is to be exposed for use. In some embodiments, the release liner is disposed on the outer most sheets of exposed adhesive layer, of the adhesive film as a protective coating during storage and shipping. The release liners in the present invention are not particularly limited. In some embodiments, the release liner can comprise materials well known in the art, such as polyolefins (e.g., polyethylene, polyethylene terephthalate, polypropylene, etc.), silicones, or fluoropolymeric materials. In some embodiments, the release liners can comprise generic materials (e.g., polymers, cellulose, paper, etc.) that are coated with non-stick materials, such as silicone, to make them releasable, such as siliconized paper.

The release liner can be a member which includes a liner base and a release layer (releasing coating film). In some embodiments, the release liner can be disposed on the second side of the backing layer so that the release layer faces outward from the backing layer. The release layer can be formed from, for example, a silicone-based release agent. Examples of silicone-based release agents include thermosetting silicone-based release agents and silicone-based release agents curable with ionizing radiation. Materials usable for forming the release layer are not limited to silicone-based release agents, and a suitable one can be selected in accordance with the kind of adhesive constituting the adhesive layer. Although the thickness of the release liner can be suitably set, in some embodiments the thickness thereof can be a value in the range of about 10 μm to about 145 μm. In some embodiments, the release liner can be about 10 to about 25 μm, about 25 to about 40 μm, about 40 to about 55pm, about 55 to about 70 μm, about 70 to about 85 μm, about 85 μm to about 100 μm, about 100 to about 115 μm, about 115 to about 130 μm, about 130 to about 145 μm, about 20 μm, about 25 μm, about 30 μm about 35 μm, about 40 μm, about 45 μm, about 50 μm, or any thickness bound by these ranges.

In some embodiments, the release liner can be comprised of polyethylene terephthalate silicon materials.

### Log Roll

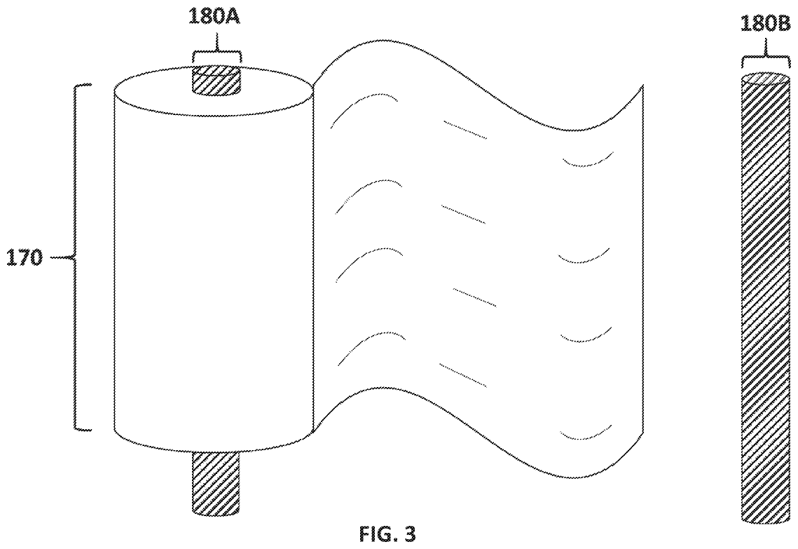

In some embodiments, the adhesive film comprises a log roll 270, constructed of an adhesive film wound around a cylindrical core 271, wherein the adhesive layer is medial and in physical communication with the cylindrical core and the backing layer is lateral to the cylindrical core, as shown in FIG. 2A. In some embodiments, the log roll can be comprised of a long continuous sheet of the aforedescribed adhesive film for attracting and capturing flying insects 170, as shown in FIG. 3, affixed to a first mount 180A. In some embodiments, the adhesive film can comprise a barrier style trap. In some embodiments, the barrier trap comprises a bottom edge and a top edge. In other embodiments, the bottom edge is located as close to the ground as possible. In some embodiments, the top edge of the barrier trap extends vertically up to a height that is in the range of about 12 cm to about 1 m, or up to about 2 m.

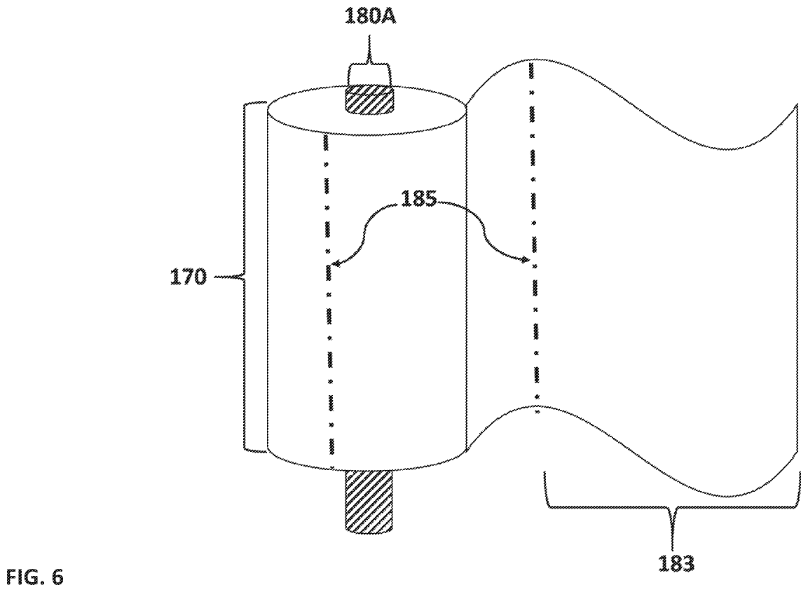

In other embodiments, the adhesive film comprises a log roll constructed of perforated adhesive film sheet wound around a cylindrical core wherein the backing layer is medial and in physical communication with the cylindrical core and the adhesive layer is lateral to the cylindrical core and the perforations create individual adhesive sheets 285, FIG. 2C, which can be individually separated from the log roll when a sufficient amount of force is applied, as shown in FIG. 2C. In another iteration, the log roll is constructed with perforated adhesive film sheets wound around a cylindrical core wherein the release liner of the adhesive film is medial and faces toward the cylindrical core, the backing layer is intermediate to the release liner and the adhesive layer, and wherein the adhesive layer is lateral/facing outward from the cylindrical core, see FIG. 2D. The log roll comprised of perforated individual sheets is similar to that of a lint roller or paper towel roll, where a top sheet may be removed from the roll when there is a sufficient amount of force applied. In some embodiments, the log roll can comprise the adhesive film for attracting and capturing flying insects (see FIG. 6), wherein the film is perforated, 185, forming a log roll comprised of layered individual sheets, 183. The log roll comprised of perforated adhesive film sheet is similar to a lint roller, wherein the outer most sheet can be peeled away from the roll once it has been exhausted. In some embodiments, the top or exposed sheet of the layered individual sheets of the adhesive film may be removed when exhausted, exposing a fresh new sheet. The log rolls are preferably about 12 cm to about 250 cm wide, more preferably 38 cm to about 60 cm wide, and most preferably 50 cm to about 100 cm wide.

### Methods of Use

An adhesive film for attracting and capturing flying insects, such as the log roll described in the present disclosure (270 in FIGS. 2A, 2B, 2C, and 2D), may be used in methods for fly control in livestock pasture or pen settings. The methods comprise the step of a) locating a livestock pasture or pen in need of flying insect control; b) erecting a plurality of mounting devices (see

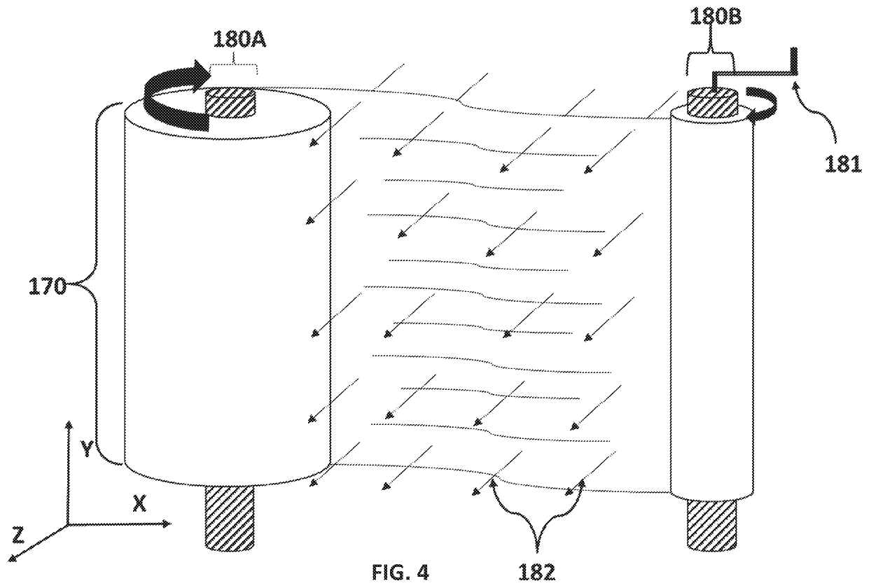

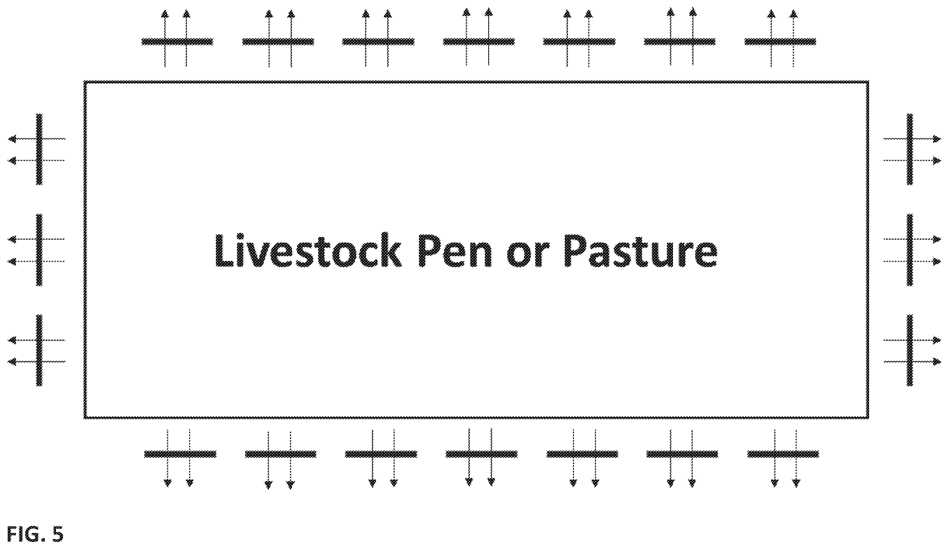

FIG. 5) for the mounting of the log rolls around at least a portion of the outer perimeter of the livestock pasture or pen such that the pasture or pen is flanked by the mounting devices, the mounting devices comprising a first mount, 180A, and a second mount, 180B, spaced out up to 3-meter distance from each other and running parallel to the perimeter of the livestock pasture or pen; c) mounting a log roll of adhesive film for attracting and capturing flying insects on the first mount; and d) unwinding the log roll of adhesive film for attracting and capturing flying insects and attaching (e.g., fixably or movably) the film to the second mount (FIG. 3), 180B, thereby creating a barrier trap, as shown in FIG. 4. The placement and securing of the mounting devices can utilize any method that is known, such as securing the devices into the ground with cement, burying a portion of the device such that they are securely affixed within the ground, use of a large base, such as a base plate, where the base is able to support the insect attracting and capturing film barrier 182, as shown in FIG. 4. The method of mounting the insect attracting and capturing film to the second mount may be accomplished by any manner suitable for mounting a film to a mount, such as by way of a groove in the mount to allow for the film to be slid in and then wound upon itself, by a mechanical means such as clips, or even by the adhesive strength of the adhesive layer itself, holding the film as it is wound upon itself in the second mount. It should be understood that the method of mounting the mounting device and the film to the mounting device is not limited and one skilled in the art would recognize alternative methods for mounting the mounting devices and the film to the mounts. It should further be understood that the direction that the adhesive layer of the insect attracting and capturing film faces is not limited; it is believed that the olfactory simulant will attract the insects whether the odor is released facing toward or away from the livestock pasture or pen, as shown in FIG. 4. In some embodiments, the adhesive layer can be directed inward toward the livestock pasture or pen in need of fly control. In other embodiments, the adhesive layer can be directed outward from the livestock pasture or pen in need of fly control. In some embodiments, the log roll is mounted, wherein the bottom edge of the log roll is located at substantially ground level creating a barrier that blocks a substantial amount of the flight path of the flies.

In some embodiments, the second mount, 180B, includes a method for winding, 181, the log roll of adhesive film onto the second mount, as shown in FIG. 4. The method of winding the film onto the second mount, 180B can be accomplished by, for example, an electric motor, a fixed handle, a detachable handle, or a long object that is fitted into a hole within the top portion of the second mount, which allows for the turning and winding of the insect attracting and capturing film. The method of winding the film onto the second mount is not limited and one skilled in the art could contemplate alternative methods to accomplish the winding of the film.

In another embodiment, the method can further be comprised of winding the film onto the second mount at such a time as when the exposed section the film barrier between the first mount and the second mount is exhausted and in need of a fresh portion of adhesive film for attracting and capturing flying insects to be exposed.

In another embodiment, a method for using a log roll of adhesive film for attracting and capturing flying insects comprises the steps of: a) identifying a livestock pasture or pen in need of flying insect control; b) erecting a plurality of log rolls of perforated individual sheets of adhesive film for attracting and capturing flying insects (see FIG. 6) near or around a livestock pasture or pen; c) exposing the adhesive film to the environment; d) removing the outermost individual sheet, 183, of the adhesive film when the outer layer is exhausted, thereby revealing a fresh layer of the adhesive film, as shown in FIG. 6; e) repeating steps a, b, c, and d as needed and then replacing the log roll when all the sheets have been depleted; and f) repeating the steps, a, b, c, d, and e as needed. The aforedescribed log roll comprised of perforated adhesive film sheet is constructed by winding a perforated adhesive film sheet for attracting and capturing flying insects onto a cylindrical core such that the backing layer, 240, is medial and in physical communication with the cylindrical core, 271, and the adhesive layer, 210, is lateral to the cylindrical core, 271, as shown in FIG. 2C. The film is perforated, 185, allowing for the log roll to be comprised of a plurality of individual sheets of the adhesive film for attracting and capturing flying insects, wherein the first or outermost sheet on a new log roll is further comprised of a release liner, 220 (see FIG. 2C, which protects the outermost adhesive layer, until such a time as the log roll is to be used, then the outermost adhesive sheet's release liner is removed exposing the adhesive layer to be used in methods for insect control in confined pasture or livestock pen settings). The methods comprise locating a livestock pasture or pen in need of insect control, such as a livestock pen or pasture where cattle graze.

The following embodiments are contemplated.

Embodiment 1 An adhesive for attracting and capturing flying insects comprising:

an adhesive material, the adhesive material being sufficiently tacky to act as a physical restraint to flying insects that contact the adhesive material;

at least one olfactory attractant; and

a tackifier.

Embodiment 2 The adhesive of embodiment 1, wherein the adhesive material is comprised of an acrylic polymer, a polyisobutylene, a polybutene, a synthetic rubber, or combinations thereof.

Embodiment 3 The adhesive of embodiment 2, wherein the adhesive material is comprised of an acrylic polymer.

Embodiment 4 The adhesive material of embodiment 3, wherein the acrylic polymer is comprised of 2-methylhexyl acrylate, an n-butyl acrylate, acrylic acid, or combinations thereof.

Embodiment 5 The adhesive of embodiment 1, wherein the at least one olfactory attractant is comprised of the tackifier, a volatile organic small molecule, or combinations thereof.

Embodiment 6 The adhesive of embodiment 5, wherein the volatile organic small molecule olfactory attractant is miscible in the adhesive material.

Embodiment 7 The adhesive of embodiment 6, wherein the volatile organic small molecule comprises a phenol, m-cresol, p-cresol, 1-octen-3-ol, 1-hexanol, or combinations thereof.

Embodiment 8 The adhesive of embodiment 1, wherein the tackifier comprises a rosin ester, a xylene resin, a terpene resin, an aliphatic/aromatic hydrocarbon resin, or combinations thereof.

Embodiment 9 The adhesive of embodiment 9, wherein the rosin ester tackifier comprises a hydrogenated rosin ester.

Embodiment 10 The adhesive of embodiment 1, wherein the amount of tackifier comprises about 60 wt % to about 200 wt % of the total weight of the adhesive material.

Embodiment 11 The adhesive of embodiment 1, wherein the flying insects comprise flies of the genus Stomoxys.

Embodiment 12 The adhesive of embodiment 1, wherein the flying insects comprise a stable fly (Stomoxys calcitrans).

Embodiment 13 An adhesive film, wherein the film is comprised of a backing layer and an adhesive layer comprised of the adhesive material of any one or more of embodiments 1, 2, 3, 4, 5, 6, 7, 8, 9, 10, 11, or 12.

Embodiment 14 The adhesive film of embodiment 13, wherein the adhesive layer is about 25 μm to about 100 μm thick.

Embodiment 15 The adhesive film of embodiment 13, wherein the backing layer is comprised of a polyethylene terephthalate material.

Embodiment 16 The adhesive film of embodiment 13, wherein the adhesive film further comprises a visual attractant.

Embodiment 17 The adhesive film of embodiment 16, wherein the visual attractant is the color white.

Embodiment 18 The adhesive film of embodiment 16, wherein the visual attractant is a striped black and white pattern.

Embodiment 19 The adhesive film of embodiment 16, wherein the visual attractant is comprised of the backing layer.

Embodiment 20 The adhesive film of embodiment 13, further comprising a release liner. Embodiment 21 The adhesive film of embodiment 13, wherein the film comprises a log roll.

Embodiment 22 The log roll of embodiment 21, wherein the log roll comprises any one or more of the adhesive film of embodiments 13, 14, 15, 16, 17, 18, 19, or 20 wound around a cylindrical core, wherein the adhesive layer of the adhesive film is proximal and in physical contact with the cylindrical core and backing layer is distal to the cylindrical core.

Embodiment 23 The log roll of embodiment 21, wherein the film comprises an insect barrier trap, comprising a bottom edge and a top edge, the bottom edge is located as close to the ground as possible and the top edge of the barrier trap extends up to a height that is in the range from about 12 cm to about 2 meters above the ground level. Embodiment 24 A method of using a barrier trap comprised of a log roll of adhesive film for attracting and capturing flying insects around a livestock pasture or pen comprising the steps of:

a. locating a livestock pasture or pen in need of flying insect control;

b. erecting a plurality of mounting devices for the mounting of the log rolls around at least a portion of the outer perimeter of the livestock pasture or pen such that the pasture or pen is flanked by the mounting devices, the mounting devices comprising a first mount and a second mount, spaced out up to 3-meter distance from each other and running parallel to the perimeter of the livestock pasture or pen;

c. mounting a log roll of adhesive film for attracting and capturing flying insects on the first mount; and

d. unwinding the log roll of adhesive film for attracting and capturing flying insects and fixably or movably attaching the film to the second mount, creating a barrier trap.

Embodiment 25 The method of embodiment 24, wherein the log roll of adhesive film for attracting and capturing flying insects is mounted such that when the barrier trap is created, the barrier trap comprises a bottom edge and a top edge, and the bottom edge of the barrier trap is located as close to ground level as possible extending upward, so that the barrier is substantially within the flight path of the flies.

Embodiment 26 The method of embodiment 24, further comprising winding the film onto the second mount at such a time as when the exposed portion of film's adhesiveness is exhausted and a fresh area of film for attracting and capturing flying insects is needed.

Embodiment 27 The adhesive film of embodiment 21, wherein the film comprises a log roll constructed of a perforated adhesive film wound around a cylindrical core, wherein the backing layer is proximal and in physical contact with the cylindrical core and adhesive layer is distal to the tubular core and the perforations create individual adhesive sheets which can be individually separated from the log roll when a sufficient amount of force is applied.

Embodiment 28 The log roll of embodiment 27, further comprising a release liner, wherein the release liner is disposed on and in physical communication with the adhesive layer.

Embodiment 29 A method for using a log roll of at least one of embodiments 27 or 28 comprising the steps of:
a. identifying a livestock pasture or pen in need of flying insect control;
b. erecting a plurality of log rolls of perforated individual sheets of adhesive film for attracting and capturing flying insects near or around a water source located within the livestock pasture or pen;
c. removing the outer release liner contained on the log roll;
d. removing the outer sheet of the adhesive film at such a time as needed, when the outer layer is exhausted, revealing a fresh layer and continuing the process until the log roll of perforated adhesive film for attracting and capturing flying insects runs out of film;
e. replacing the log roll of perforated adhesive film for attracting and capturing flying insects with a new log roll; and
f. repeating the steps, a, b, c, d, and e as needed.

### EXAMPLES

It should be appreciated that the following Examples are for illustration purposes and are not intended to be construed as limiting the subject matter disclosed in this document to only the embodiments disclosed in these examples.

Is has been discovered that the embodiments of the adhesive film for attracting and capturing flying insects described herein can control stable fly populations within a pasture or livestock pen environment, thus reducing the number of stable flies around and on the livestock. These benefits are further shown by the following examples, which are intended to be illustrative of the embodiments of the present disclosure, but are not intended to limit the scope or underlying principles in any way.

### Example 1: Preparation of Acrylate Monomer Based Polymer

63 mass parts of 2-methyl hexyl acrylate, 29 mass parts of n-butyl acrylate, 1 mass part of acrylic acid and 60 mass parts of ethyl acetate (based on 100 parts (solid basis) of the monomers) as introduced into a reaction vessel equipped with a condenser tube, a nitrogen introducing tube, a thermometer, and a stirrer. The mixture was stirred at room temperature while nitrogen gas was introduced, for about 1 hour to remove the oxygen from the reaction system. 120 mass parts of hydrogenated rosin ester, as a tackifier, and 10 mass parts of m-cresol, as an olfactory attractant, were added, and the mixture was mixed/stirred for about 5-6 hours for polymerization.

### Example 2: Preparation of Adhesive for Attracting and Capturing Flying Insects

Based on 100 parts of the solid monomer in the acrylic monomer based polymer from Example 1, 0.1 parts of trimethylolpropane xylene diisocyananate (Takenate D110N, Mitsui Chemicals, Inc., Tokyo, Japan), 0.3 parts of dibenzoyl peroxide, 0.1 parts of γ-glycidoxypropylmethoxysilane (KBM-403, Shin-Etsu Chemical Co., Ltd., Tokyo, Japan) and 1 part of lithium bis(nonafluorobutanesulfonyl)imide (EF-N445, Mitsubishi Materials Electronic Chemicals Co., Ltd., Akita, Japan) were added to the acrylic monomer based polymer solution to form an acrylic based adhesive solution.

Based on weight measurements, 100 parts of the liquid acrylic resin (BPS4891TX from Toyolnk) and 120 parts Rosin Ester Gum tackifier (EsterGum from Arakawa) was added into a beaker and mixed thoroughly. Next, 110 parts of ethyl acetate was added and mixed again. Finally, 22 parts of m-cresol was added and mixed thoroughly to create an adhesive solution.

For sample adhesive containing phenol, p-cresol and 1-octen-3-ol, the adhesives were prepared the same as for the m-cresol except substituting in the other olfactory attractants in place of m-cresol. The control was prepared as above minus any m-cresol or other olfactory attractant.

### Example 3: Preparation of Adhesive Film Log Roll for Attracting and Capturing Flying Insects

One surface of a polyethylene terephthalate (PET) film was treated with a silicon releasing agent. Next, a solution of adhesive material (as described in Example 2) was uniformly applied with a bar coater to the non-treated surface of the PET film (backing layer) and then allowed to dry in an air circulating-type thermostatic oven at 130° C. for 3 minutes until a 63.5 μm thick adhesive layer was formed. Next, a Silphan 1R10003 laminated liner (Siliconature LLC, USA) was disposed on the adhesive layer of the PET film for protection during production. Subsequently, the laminated liner was removed and the adhesive layer was bonded to a cylindrical core, then wound upon the core until a log roll (about 25 yards for experimental procedures) was produced. The log rolls were then sealed in an aluminum heat sealing bag for storage, until such time as needed.

### Example 4: Release of M-Cresol from an Adhesive Film for Attracting and Capturing Flying Insects Field Test

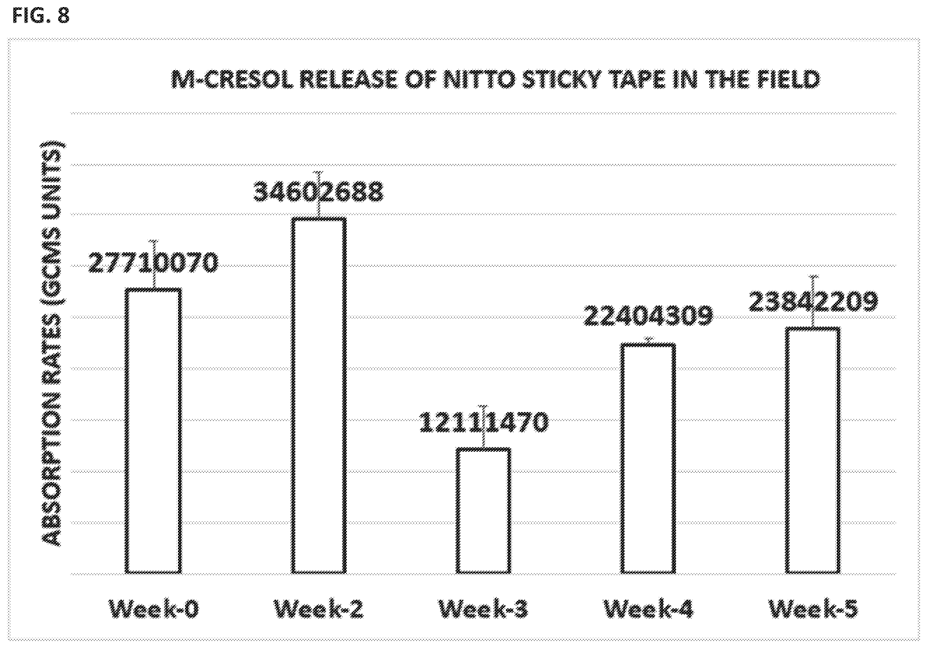

Log rolls of the adhesive film for attracting and capturing flying insects, made according to Examples 1, 2 and 3 above, were mounted low to the ground (about 7 to 8 cm above ground level) on a first mount of a mounting device, and extending upwards for about 65 to 70 cm (about the height of livestock legs) and horizontally, for about 1 meter, between the first mount and a second mount of the mounting device. A plurality of the mounting devices was placed around a livestock grazing pasture. At least one pole, of about 1 yard in height, was placed around the center of the extended film in order to support the film and reduce sagging. Every week, for six weeks, the log roll was wound by the second mount to expose a fresh area of the adhesive film for attracting and capturing flying insects. At weeks 0, 2, 3, 4, 5, and 6, a fresh 4 cm×4 cm piece of the fresh film was removed and taken to the lab to test the amount of m-cresol being released from the sample. A Gas Chromatographer Mass Spectrometer single ion (m/z 108) analysis was performed on the samples. The results are shown in FIG. 8.

### Example 5: Solid Phase Micro Extraction (SPME) Absorption

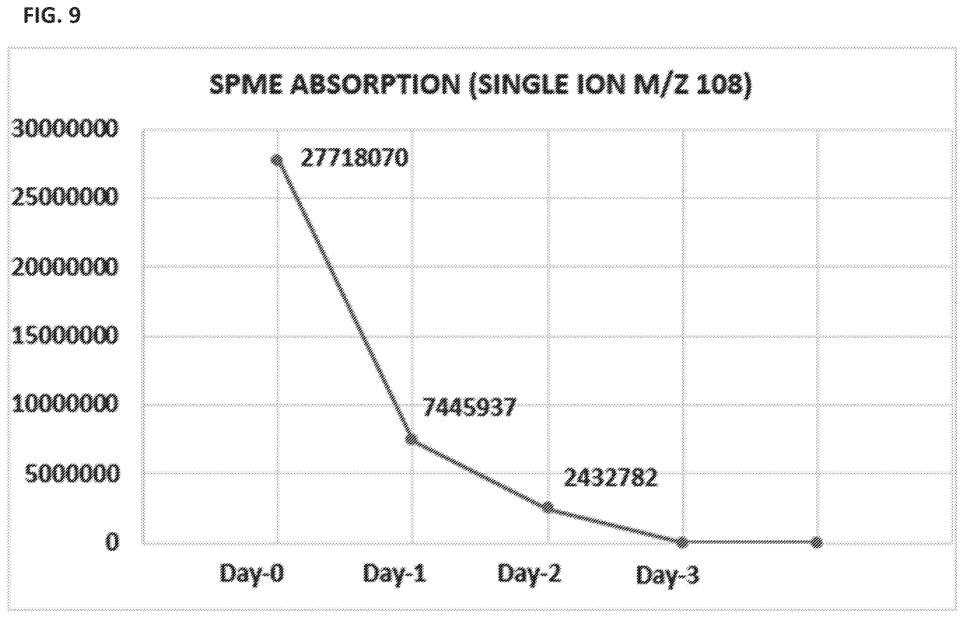

Log rolls of the adhesive film for attracting and capturing flying insects, made according to Examples 1 to 3 above, were mounted low to the ground (about 7 to 8 cm above ground level) on a first mount of a mounting device, and extending vertically for about 65 to 70 cm (about the height of livestock legs) and horizontally, for about 1 meter, between the first mount and a second mount of a mounting device. A plurality of mounting devices was placed around a livestock grazing pasture. At days 0, 1, 2, 3 and 4, a fresh 4 cm×4 cm piece of the fresh film was removed and taken to the lab to test the amount of m-cresol being released from the sample. The samples were place in a 100 mL beaker with a 100 um polydimethylsiloxane SPME fiber (Millipore Sigma, Burlington, Mass., USA) sample, for 18 hours. A Gas Chromatographer Mass Spectrometer single ion (m/z 108) analysis was performed on the samples. The results are shown in FIG. 9.

### Example 6: Characterization of Attractants' Effectiveness

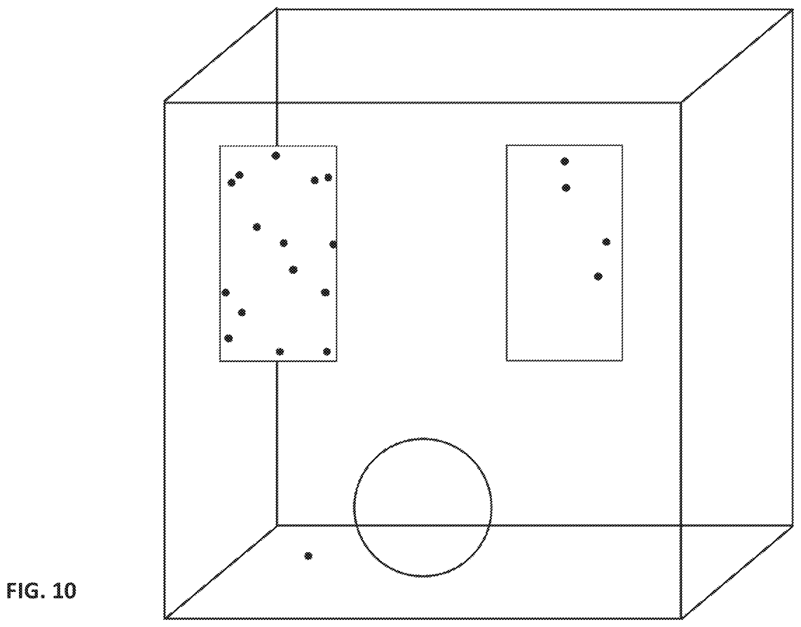

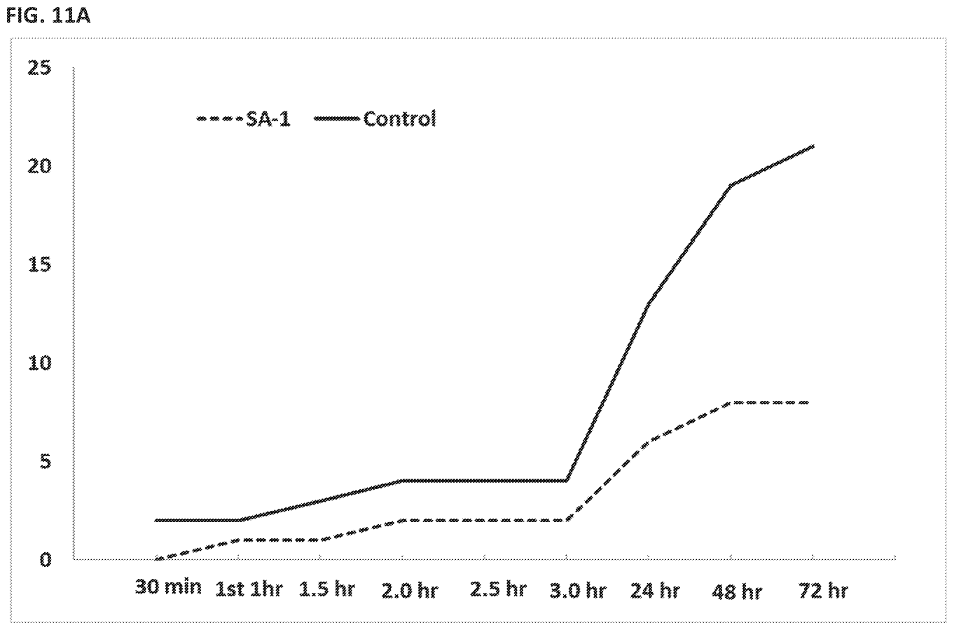

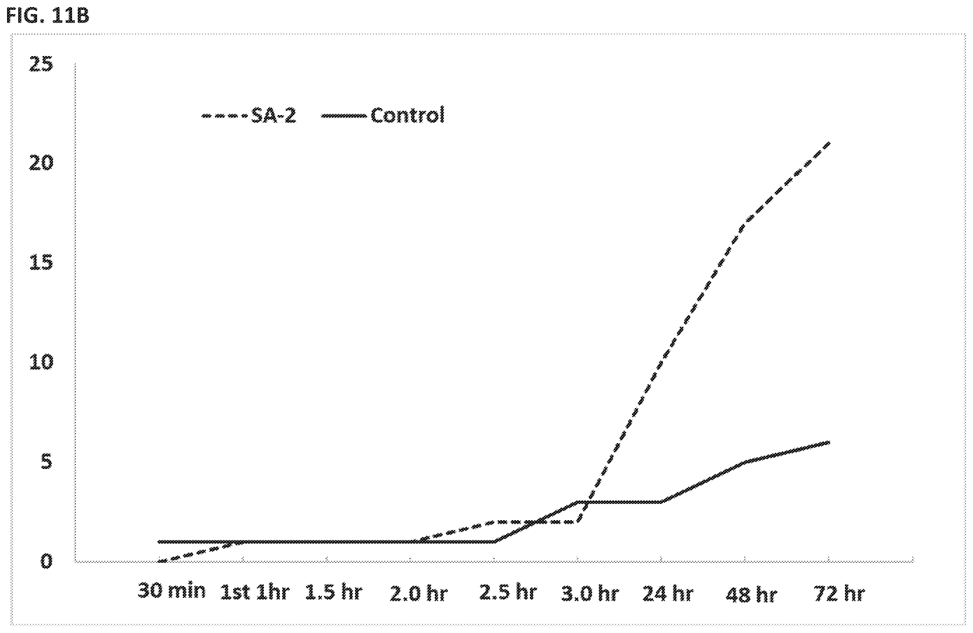

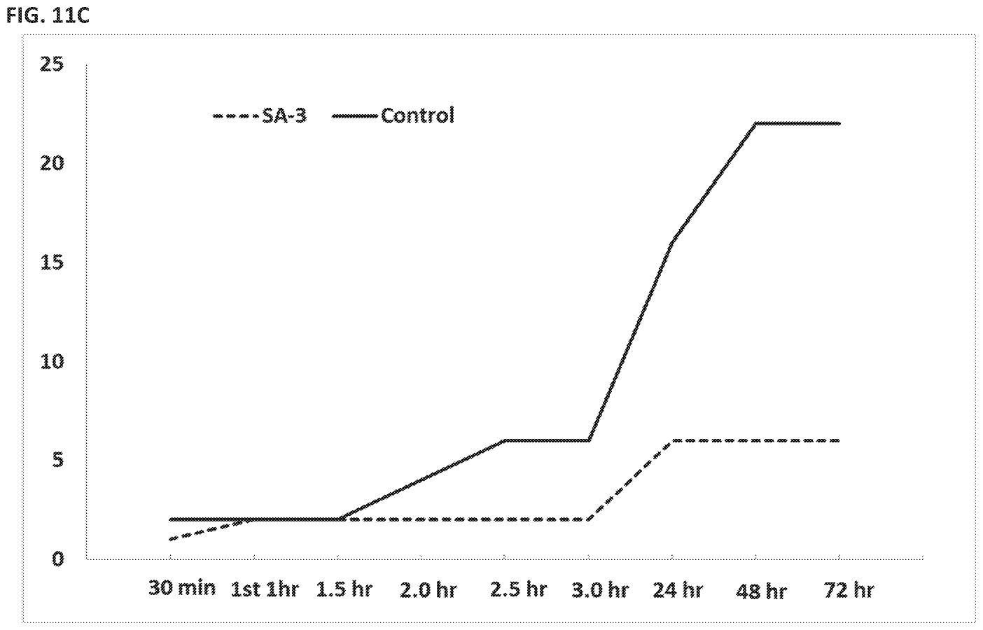

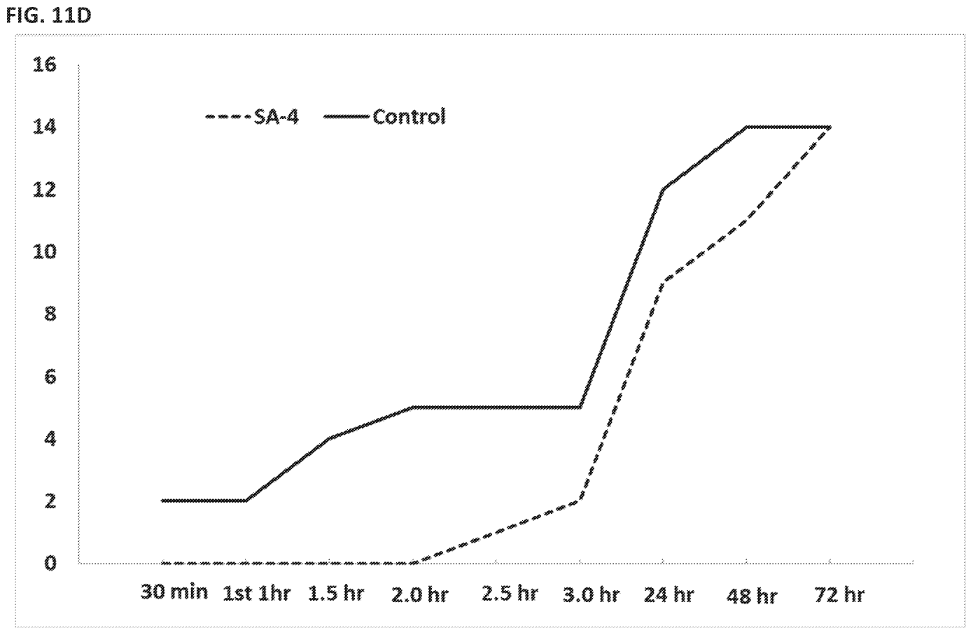

The aforedescribed (see examples 1, 2, and 3) adhesive film, cut into eight 10 cm×14 cm strips, were made. The olfactory attractant contained in one sample strip was 1-octen-3-ol (SA-1); a second sample strip contained m-cresol (SA-2); a third sample strip contained phenol (SA-3); and a fourth sample strip contained p-cresol (SA-4), and four additional strips did not comprise any olfactory attractants and were used as controls. One strip was affixed onto a wall inside a screen cage a distance away from a control strip, and then thirty stable flies were released into the cage; this step was repeated for the remaining sample strips and controls (FIG. 10). The number of flies caught on each of the sample strips and the controls were observed at intervals of 30 mins, 1 hour, 1.5 hours, 2.0 hours, 2.5 hours, 3.0 hours, 24 hours, 48 hours, and 72 hours and the observations were recorded. SA-2 (m-cresol) was found to be most effective at attracting the stable flies (FIG. 11B) compared to its control and compared to SA-1 (FIG. 11A; 1-octen-3-ol), SA-3 (FIG. 11C; phenol), and SA-4 (FIG. 11D; p-cresol). SA-2 showed a 3-fold increase in the number of flies over control (the controls have no olfactory attractant), wherein the SA-1 (1-octen-3-ol) and the SA-3 (phenol) showed around a 2.5-fold decrease in attractiveness over the control and wherein the SA-4 (p-cresol) was about the same as the control for attractiveness over the 48-hour time period.

### Example 7: Characterization of Adhesive Film's Effectiveness at Reducing Number of Stable Flies that Attack Cattle Control

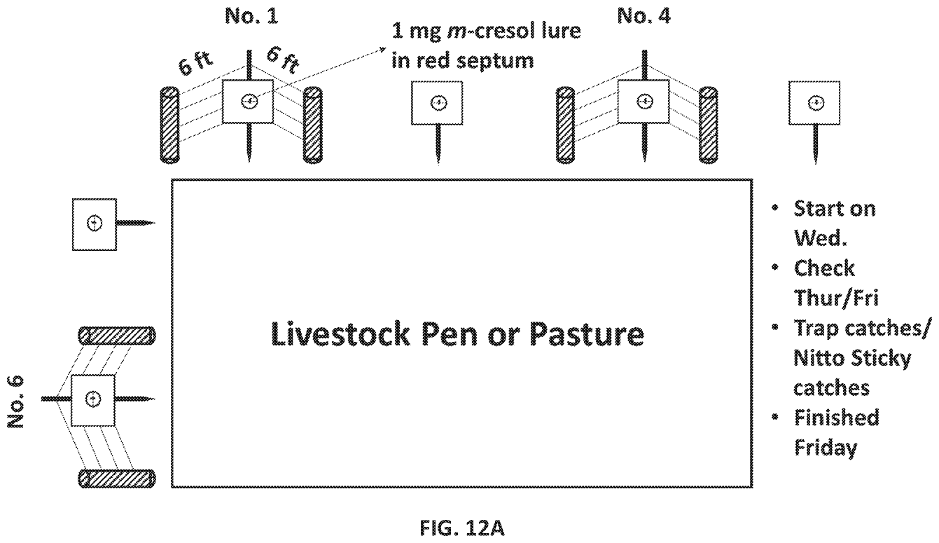

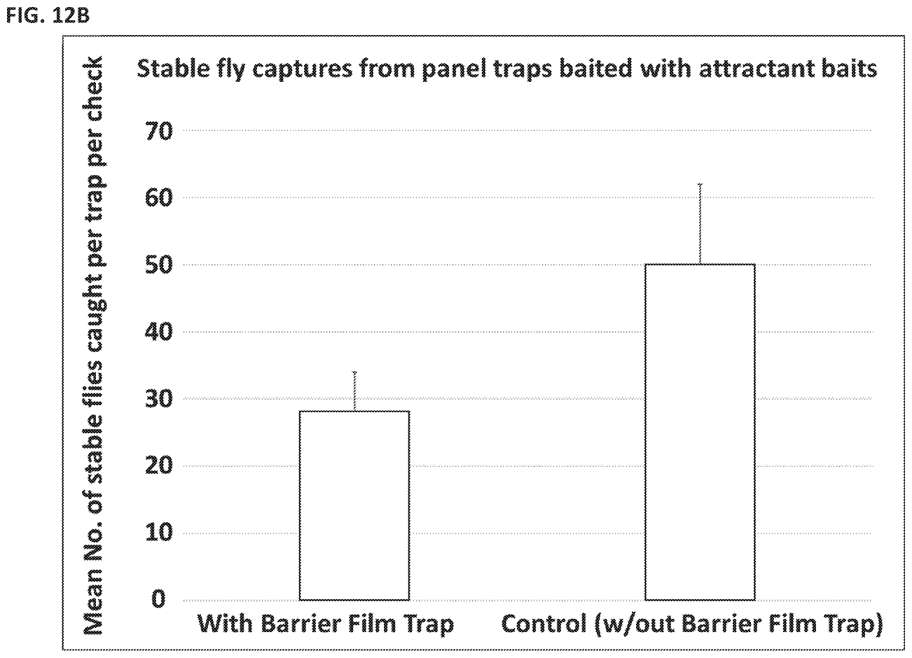

Log rolls of the adhesive film for attracting and capturing flying insects, were made according to Examples 1, 2, and 3 above but without any olfactory attractants. They were mounted low to the ground on a first mount of a mounting device and extending upwards for about 1 meter (about the height of livestock legs) and horizontally for about 2 meters, between the first mount and a second mount of the mounting device. One pole of about 1 meter in height was placed in contact with the adhesive layer approximately in the middle of the extended film. The pole was positioned so that the opposing sides of the extended film were at a 60 degrees angle from one another, in order to reduce sagging within the extended film. A cattle mimicking device was positioned, comprising a panel of about 1 meter×60 cm of a generic adhesive film and a red rubber stopper infused with 1 mg of m-cresol, in the middle of each panel. A standalone cattle mimicking device (i.e. not surrounded by log rolls of the adhesive film) was also placed to the right of each mounting device to serve as controls. A total of three mounting devices and six cattle mimicking devices were set up in an area prone to stable fly activity (see FIG. 12A) for three days. On the second and the third day, the number of flies captured on the adhesive film located behind the cattle mimicking devices were counted. It was observed that the mean number of stable flies caught on the cattle mimicking devices placed in front of the mounting devices was 64% less than the mean number of stable flies caught on the standalone cattle mimicking devices. This result indicates that the placement of a barrier style adhesive film trap near a cattle mimic device results in a lower number of flies attacking the cattle mimic devices. The results are graphically illustrated in FIG. 12B.

### Example 8: Field Test of Adhesive Films with and without Visual and Olfactory Attractants

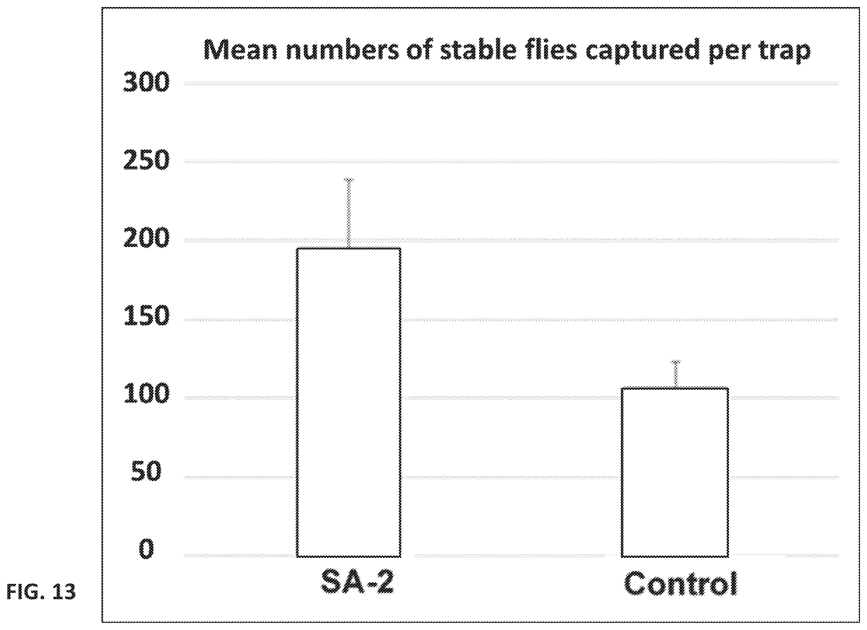

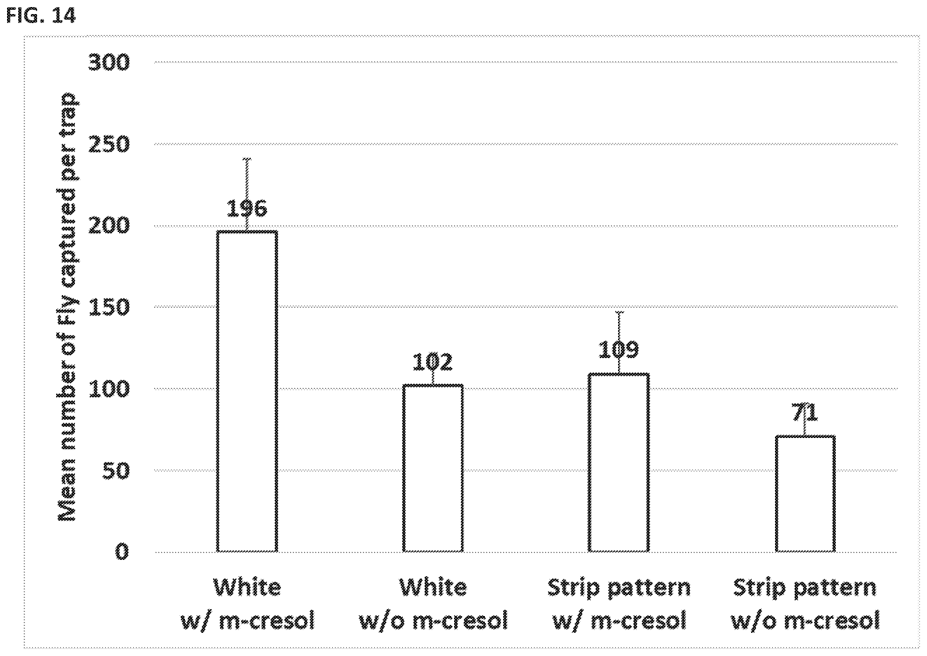

Adhesive film traps measuring 11 inches×11 inches with an effective trapping area of 99 square inches on both sides were tested. Traps were constructed using the adhesive material described in Example 2, with and without m-cresol. Traps were also constructed with a visual attractant or without. The visual attractant comprised alternating vertical white and black stripes or a solid white backing. The traps comprised of the white background with and without m-cresol were paired together and the traps comprised of the vertical white and black stripes with and without m-cresol were paired. The trap pairs were deployed in a grass field adjacent to a cattle pen, approximately 4.5 to 5 meters for the cattle pens. The trap pairs were place one meter apart (inner edge from inner edge). The two differing trap pairs were alternately deployed in the grass field at a distance of 15 meters between pairs. The height from the ground to the top edge of the traps were about 15-18 inches or about 45 cm (or about 18 inches). A total of 10 pairs of traps, 5 pairs with white background and 5 pairs with white and black vertical stripes, were deployed. The traps were deployed at day 0 and on day 1 the total number of flies caught were recorded. After day 1 the m-cresol and the non m-cresol traps positions were switched. On day 2 the total number of flies caught were recorded. The recorded data from day 1 and day 2 were combined, and the traps with white background with m-cresol exhibited about a 2-fold increase in the number of flies captured when compared to the white background without m-cresol, FIG. 13. The data also indicates that the traps with a white visual attractant with m-cresol exhibited about a 2-fold increase in the number of flies captured over the trap with a white and black striped visual attractant, FIG. 14. Also, the traps with the solid white visual attractant were about as effective at capturing flies as those with a white and black visual attractant combined with the m-cresol; results are graphically illustrated in FIG. 14.

For the processes and/or methods disclosed, the functions performed in the processes and methods may be implemented in differing order, as may be indicated by context. Furthermore, the outlined steps and operations are only provided as examples, and some of the steps and operations may be optional, combined into fewer steps and operations, or expanded into additional steps and operations.

This disclosure may sometimes illustrate different components contained within, or connected with, different other components. Such depicted architectures are merely exemplary, and many other architectures can be implemented which achieve the same or similar functionality.

The terms used in this disclosure, and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.). In addition, if a specific number of elements is introduced, this may be interpreted to mean at least the recited number, as may be indicated by context (e.g., the bare recitation of “two recitations,” without other modifiers, means at least two recitations, or two or more recitations). As used in this disclosure, any disjunctive word and/or phrase presenting two or more alternative terms should be understood to contemplate the possibilities of including one of the terms, either of the terms, or both terms. For example, the phrase “A or B” will be understood to include the possibilities of “A” or “B” or “A and B.”

By the term “substantially” it is meant that the recited characteristic, parameter, or value need not be achieved exactly, but that deviations or variations, including for example, tolerances, measurement error, measurement accuracy limitations and other factors known to those skilled in the art, may occur in amounts that do not preclude the effect the characteristic was intended to provide.

Aspects of the present disclosure may be embodied in other forms without departing from its spirit or essential characteristics. The described aspects are to be considered in all respects illustrative and not restrictive. The claimed subject matter is indicated by the appended claims rather than by the foregoing description. All changes which come within the meaning and range of equivalency of the claims are to be embraced within their scope.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

The terms “a,” “an,” “the” and similar referents used in the context of describing the invention (especially in the contest of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of any claim. No language in the specification should be construed as indicating any non-claimed element essential to the practice of the invention.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, the claims include all modifications and equivalents of the subject matter recited in the claims as permitted by applicable law. Moreover, any combination of the above-described elements in all possible variations thereof is contemplated unless otherwise indicated herein or otherwise clearly contradicted by context.

In closing, it is to be understood that the embodiments disclosed herein are illustrative of the principles of the claims. Other modifications that may be employed are within the scope of the claims. Thus, by way of example, but not of limitation, alternative embodiments may be utilized in accordance with the teachings herein. Accordingly, the claims are not limited to embodiments precisely as shown and described.

### LEGEND

110: adhesive layer

111: olfactory attractant

112: adhesive material

113: tackifier

170: adhesive film

180A: first mount

180B: second mount

181: method for winding

182: film barrier

183: individual sheets

185: perforations

210: adhesive layer

211: olfactory attractant

212: adhesive material

213: tackifier

214: visual attracting component

220: release liner

240: backing layer

250: adhesive film

270: log roll

271: cylindrical core

285: adhesive sheets

What is claimed:

1. An adhesive for attracting and capturing flying insects comprising:
an adhesive material, wherein the adhesive material is sufficiently tacky to act as a physical restraint when flying insects contact the adhesive material;
at least one olfactory attractant, wherein the olfactory attractant comprises a volatile small molecule; and
a tackifier.

2. The adhesive of claim 1, wherein the adhesive material comprises an acrylic polymer, a polyisobutylene, a polybutene, a synthetic rubber, or a combination thereof

3. The adhesive of claim 1 or 2, wherein the adhesive material is comprised of 2-methylhexyl acrylate, n-butyl acrylate, acrylic acid, or a combination thereof.

4. The adhesive of claim 1, 2, or 3, wherein the at least one olfactory attractant is miscible in the adhesive material.

5. The adhesive of claim 1, 2, 3, or 4, wherein the at least one olfactory attractant is comprised of a volatile organic small molecule.

6. The adhesive of claim 4 or 5, wherein the volatile organic small molecule comprises m-cresol, p-cresol, 1-octen-3-ol, 1-hexanol, or combinations thereof.

7. The adhesive of claim 4, 5, or 6, wherein the volatile organic small molecule comprises m-cresol.

8. The adhesive of claim 1, 2, or 3, wherein the tackifier comprises rosin ester, xylene resin, terpene resin, an aliphatic/aromatic hydrocarbon resin, or combinations thereof.

9. The adhesive of claim 8, wherein the tackifier comprises hydrogenated rosin ester.

10. The adhesive of claim 1, 2, 3, 4, 5, 6, 7, 8, or 9, wherein the amount of tackifier comprises about 60 to 200 wt % of the total weight of the adhesive material.

11. The adhesive of claim 1, 2, 3, 4, 5, 6, 7, 8, 9, or 10, wherein the tackifier further comprises an olfactory attractant.

12. The adhesive of claim 1, 2, 3, 4, 5, 6, 7, 8, 9, 10, or 11, wherein the adhesive attracts and captures flying insects of the genus Stomoxys.

13. The adhesive of claim 1, 2, 3, 4, 5, 6, 7, 8, 9, 10, 11, or 12, wherein the adhesive attracts and captures stable flies (Stomoxys calcitrans).

14. An adhesive film comprising:
a backing layer, wherein the backing layer comprises two opposing surfaces; and
an adhesive layer comprised of the adhesive of any of claim 1, 2, 3, 4, 5, 6, 7, 8, 9, 10, 11, 12, or 13, wherein the adhesive layer is disposed on at least one of the opposing surfaces of the backing layer.

15. The adhesive film of claim 14, wherein the thickness of the adhesive layer is about 25 μm to about 100 μm.

16. The adhesive film of claim 14 or 15, wherein the backing layer comprises polyethylene terephthalate.

17. The adhesive film of claim 14, 15, or 16, wherein the backing layer further comprises a visual attractant.

18. The adhesive film of claim 17, wherein the backing layer is white.

19. The adhesive film of claim 14, 15, 16, 17, or 18, further comprising a release liner, release coating, or combinations thereof.

20. The adhesive film of claim 14, 15, 16, 17, 18, or 19, wherein the release liner is disposed on a surface of the backing layer which is opposite to the surface with the adhesive layer.

21. A log roll comprising: the adhesive film of claim 14, 15, 16, 17, 18, 19, or 20, wound around a cylindrical core, wherein the release liner of the adhesive film is lateral /faces toward the cylindrical core, the backing layer intermediate the release liner and the adhesive layer, and wherein the adhesive layer is medial/facing outward from the cylindrical core.

22. The log roll of claim 21, wherein the adhesive film comprises perforations which form individual sheets, the individual sheets removable from the log roll when a sufficient amount of force is applied.

23. A method for capturing flying insects around a livestock pasture or pen using a perforated adhesive film log roll comprising the steps of:
a. Identifying a livestock pasture or pen in need of flying insect control;
b. Erecting a plurality of log rolls of claim 21 or 22, near or around a livestock pasture or pen;
c. Exposing the adhesive film to the environment;
d. Removing the outer sheet of the adhesive film when the adhesiveness of the outer layer is exhausted, revealing a fresh layer of adhesive film;
e. Repeating steps a, b, c, and d as needed and then replacing the log roll when all sheets have been depleted;
f. Repeating steps a, b, c, d, and e as needed.

24. A method of using a barrier trap comprised of a log roll of adhesive film for attracting and capturing flying insects around a livestock pasture or pen comprising the steps of:
a. Identifying a livestock pasture or pen in need of flying insect control;
b. Erecting a plurality of mounting devices for the mounting of the log rolls of claim 21 or 22, near or around a livestock pasture or pen, such that the pasture or pen is flanked by the mounting devices, the mounting devices comprising a first mount and a second mount spaced out up to a 3-meter distance from each other and running parallel to the perimeter of the livestock pasture or pen;
c. Mounting a log roll of adhesive film for attracting and capturing flying insects on the first mount; and
d. Unwinding the log roll of adhesive film for attracting and capturing flying insects and fixably attaching the film to the second mount, creating a barrier trap.
